(19) United States
(12) Patent Application Publication
(10) Pub. No.: US 2020/0056067 A1
(43) Pub. Date: Feb. 20, 2020

(54) PERFLUORO(POLY)ETHER GROUP-CONTAINING SILANE COMPOUND

(71) Applicant: DAIKIN INDUSTRIES, LTD., Osaka-shi, Osaka (JP)

(72) Inventors: Hisashi MITSUHASHI, Osaka-shi, Osaka (JP); Masatoshi NOSE, Osaka-shi, Osaka (JP); Takashi NOMURA, Osaka-shi, Osaka (JP); Shinya TAKANO, Osaka-shi, Osaka (JP); Masato NAITOU, Osaka-shi, Osaka (JP); Peter HUPFIELD, Dusseldorf (DE)

(73) Assignee: DAIKIN INDUSTRIES, LTD., Osaka-shi, Osaka (JP)

(21) Appl. No.: 16/344,670

(22) PCT Filed: Oct. 27, 2017
(86) PCT No.: PCT/JP2017/038990

§ 371 Date: Apr. 24, 2019

(30) Foreign Application Priority Data
Oct. 27, 2016 (JP) 2016-210726
Feb. 6, 2017 (JP) 2017-019755
Mar. 17, 2017 (JP) 2017-053410

(51) Int. Cl. C09D 171/02; C08G 65/336; C09D 7/20; C09D 5/00

(52) U.S. Cl. CPC C09D 171/02; C09D 5/00; C09D 7/20; C08G 65/336

(57) ABSTRACT

A perfluoro(poly)ether group-containing silane compound including a structure represented by -PFPE-X—SiR^{a}ₖR^{b}ₗR^{c}ₘ. In an exemplary embodiment, PFPE is a perfluoro(poly)ether group, X is a substituted or unsubstituted alkylene group having 2 to 20 carbon atoms, R^{a} is a functional group comprising a Si, R^{c} is a hydrogen atom or a lower alkyl group, k is an integer of 1 to 3, l and m are an integer of 0 to 2, respectively, and the sum of k, l and m in each —SiR^{a}ₖR^{b}ₗR^{c}ₘ is 3. Also disclosed is a surface-treating agent containing the silane compound, a pellet containing the surface-treating agent and an article including a base material and a layer formed from the silane compound or the surface-treating agent on a surface of the base material.

### TECHNICAL FIELD

The present invention relates to a perfluoro(poly)ether group-containing silane compound. The present invention also relates to a surface-treating agent including such a perfluoro(poly)ether group-containing silane compound.

### BACKGROUND ART

A certain fluorine-containing compound is known to be able to provide excellent water-repellency, oil-repellency, antifouling property, and the like, when used for a surface treatment of a base material. Such a fluorine-containing silane compound known is a perfluoropolyether group-containing silane compound having a perfluoropolyether group in a molecular backbone, and having a hydrolyzable group bonding to a Si atom, at a molecular terminal or a terminal portion. For example, Patent Document 1 describes a perfluoropolyether group-containing silane compound having a hydrolyzable group bonding to a Si atom, at a molecular terminal or a terminal portion.

A layer obtained from a surface-treating agent including the above fluorine-containing silane compound (hereinafter, also referred to as “surface-treating layer”) is applied as a so-called functional thin film onto glass or the like. In particular, such a surface-treating layer can exert the above functions even in the form of a thin film, and therefore is applied in an optical member required to have light permeability and/or transparency, such as glasses, a touch panel, or an operation screen of a mobile terminal.

### PRIOR ART DOCUMENT

### Patent Document

Patent Document 1: JP 2013-117012 A

### SUMMARY OF INVENTION

### Problem to be Solved by the Invention

The above surface-treating layer may be required to further have durability to ultraviolet (UV) (UV resistance). According to the studies by the present inventors, however, it has been found that a surface-treating layer formed by use of the above perfluoropolyether group-containing silane compound may achieve no sufficient UV resistance in some cases.

An object of the present invention is to provide a perfluoro(poly)ether group-containing silane compound suitable for formation of a surface-treating layer having UV resistance. Another object of the present invention is to provide a surface-treating agent including such a compound. Still another object of the present invention is to provide an article having a surface-treating layer formed by use of such a surface-treating agent.

### Solution to Problem

A first aspect of the present invention provides

a perfluoro(poly)ether group-containing silane compound represented by formula (A1) or formula (A2):

Rf-PFPE-X—SiR^{a}ₖR^{b}ₗR^{c}ₘ (A1)

R^{c}ₘR^{b}ₗR^{a}ₖSi—X-PFPE-X—SiR^{a}ₖR^{b}ₗR^{c}ₘ (A2)

wherein:

PFPE represents, each independently at each occurrence, a group represented by formula: —(OC₆F₁₂)ₐ—(OC₅F₁₀)_{b}—(OC₄F₈)_{c}—(OC₃F₆)_{d}—(OC₂F₄)ₑ—(OCF₂)_{f}— wherein a, b, c, d, e and f are each independently an integer of 0 or more and 200 or less, the sum of a, b, c, d, e and f is at least 1, and the occurrence order of respective repeating units in parentheses with a symbol a, b, c, d, e or f is not limited in the formula;

Rf represents, each independently at each occurrence, an alkyl group having 1 to 16 carbon atoms, optionally substituted with one or more fluorine atoms;

X represents, each independently at each occurrence, a substituted or unsubstituted alkylene group having 2 to 20 carbon atoms;

R^{a} represents, each independently at each occurrence, —Z—SiR¹ₚR²_{q}R³ᵣ;

Z represents, each independently at each occurrence, an oxygen atom or a divalent organic group;

R¹ represents, each independently at each occurrence, R^{a′};

R^{a′} has the same definition as R^{a};

the number of Si atoms linearly linked via Z group in R^{a} is up to 5;

R² represents, each independently at each occurrence, a hydroxyl group or a hydrolyzable group;

R³ represents, each independently at each occurrence, a hydrogen atom or a lower alkyl group;

p is, each independently at each occurrence, an integer of 0 to 3;

q is, each independently at each occurrence, an integer of 0 to 3;

r is, each independently at each occurrence, an integer of 0 to 3;

provided that the sum of p, q and r in each —Z—SiR¹ₚR²_{q}R³_{z} is 3, and two or more Si atoms having at least one R² are present in the formulae (A1) and (A2);

R^{b} represents, each independently at each occurrence, a hydroxyl group or a hydrolyzable group;

R^{c} represents, each independently at each occurrence, a hydrogen atom or a lower alkyl group;

k is, each independently at each occurrence, an integer of 1 to 3;

l is, each independently at each occurrence, an integer of 0 to 2; and

m is, each independently at each occurrence, an integer of 0 to 2;

provided that the sum of k, l and m in each —SiR^{a}ₖR^{b}ₗR^{c}ₘ is 3.

A second aspect of the present invention provides a surface-treating agent containing at least one perfluoro(poly)ether group-containing silane compound represented by the formula (A1) and/or formula (A2).

A third aspect of the present invention provides a pellet containing the above surface-treating agent.

A fourth aspect of the present invention provides an article including a base material, and a layer formed from the above compound or the surface-treating agent, on the surface of the base material.

### Effect of the Invention

The present invention can provide a perfluoro(poly)ether group-containing silane compound suitable for formation of a surface-treating layer favorable in UV resistance. The present invention can also provide a surface-treating agent including such a compound. The present invention can further provide an article including such a compound or a surface-treating agent.

### EMBODIMENTS TO CARRY OUT THE INVENTION

Hereinafter, the perfluoro(poly)ether group-containing silane compound of the present invention will be described.

As used herein, a “divalent organic group” means a carbon-containing divalent group. Such a divalent organic group is not limited, and examples thereof include a divalent group where further one hydrogen atom is removed from a hydrocarbon group.

As used herein, a “hydrocarbon group” means a group that contains carbon and hydrogen, where one hydrogen atom is removed from hydrocarbon. Such a hydrocarbon group is not limited, and examples thereof include a hydrocarbon group having 1 to 20 carbon atoms, optionally substituted with one or more substituents, for example, an aliphatic hydrocarbon group and an aromatic hydrocarbon group. For example, the “aliphatic hydrocarbon group” may be linear, branched or cyclic, and may be saturated or unsaturated. For example, the hydrocarbon group may have one or more ring structures. For example, such a hydrocarbon group may have one or more N, O, S, Si, amide, sulfonyl, siloxane, carbonyl, carbonyloxy, and other groups at a terminal or in a molecular chain.

As used herein, each substituent of the “hydrocarbon group” is not limited, and examples thereof include a halogen atom; and one or more groups selected from C₁₋₆ alkyl groups, C₂₋₆ alkenyl groups, C₂₋₆ alkynyl groups, C₃₋₁₀ cycloalkyl groups, C₃₋₁₀ unsaturated cycloalkyl groups, 5- to 10-membered heterocyclyl groups, 5- to 10-membered unsaturated heterocyclyl groups, C₆₋₁₀ aryl groups and 5- to 10-membered heteroaryl groups, which are optionally substituted with one or more halogen atoms.

The present invention provides a perfluoro(poly)ether group (hereinafter, also referred to as “PFPE”)-containing silane compound represented by formula (A1) or formula (A2) (hereinafter, also referred to as “a PFPE-containing silane compound of the present invention”).

Rf-PFPE-X—SiR^{a}ₖR^{b}ₗR^{c}ₘ (A1)

R^{c}ₘR^{b}ₗR^{a}ₖSi—X-PFPE-X—SiR^{a}ₖR^{b}ₗR^{c}ₘ (A2)

In the formulae (A1) and (A2), Rf represents, independently at each occurrence, an alkyl group having 1 to 16 carbon atoms, optionally substituted with one or more fluorine atoms.

For example, a “alkyl group having 1 to 16 carbon atoms” in the alkyl group having 1 to 16 carbon atoms, optionally substituted with one or more fluorine atoms, may be linear or branched, and is preferably a linear or branched alkyl group having 1 to 6 carbon atoms, in particular, 1 to 3 carbon atoms, more preferably a linear alkyl group having 1 to 3 carbon atoms.

Rf preferably is an alkyl group having 1 to 16 carbon atoms, substituted with one or more fluorine atoms, more preferably a CF₂H—C₁₋₁₅ perfluoroalkylene group or a C₁₋₁₆ perfluoroalkyl group, further preferably a C₁₋₁₆ perfluoroalkyl group.

For example, the perfluoroalkyl group having 1 to 16 carbon atoms may be linear or branched, and is preferably a linear or branched perfluoroalkyl group having 1 to 6 carbon atoms, in particular, 1 to 3 carbon atoms, more preferably a linear perfluoroalkyl group having 1 to 3 carbon atoms, specifically —CF₃, —CF₂CF₃, or —CF₂CF₂CF₃.

In the formulae, PFPE is, independently at each occurrence, a group represented by: —(OC₆F₁₂)ₐ—(OC₅F₁₀)_{b}—(OC₄F₈)_{c}—(OC₃F₆)_{d}—(OC₂F₄)ₑ—(OCF₂)_{f}—. In the formula, a, b, c, d, e and f are each independently an integer of 0 or more and 200 or less, and the sum of a, b, c, d, e and f is at least 1. Preferably, a, b, c, d, e and f are each independently an integer of 0 or more and 100 or less. The sum of a, b, c, d, e and f is preferably 5 or more, more preferably 10 or more. The sum of a, b, c, d, e and f is preferably 200 or less, more preferably 100 or less, for example, 10 or more and 200 or less, more specifically 10 or more and 100 or less. The occurrence order of respective repeating units in parentheses with a symbol a, b, c, d, e or f is not limited in the formula.

For example, these repeating units may be linear or branched, and is preferably linear. For example, —(OC₆F₁₂)— may be —(OCF₂CF₂CF₂CF₂CF₂CF₂)—, —(OCF(CF₃)CF₂CF₂CF₂CF₂)—, —(OCF₂CF(CF₃)CF₂CF₂CF₂)—, —(OCF₂CF₂CF(CF₃)CF₂CF₂)—, —(OCF₂CF₂CF₂CF(CF₃)CF₂)—, —(OCF₂CF₂CF₂CF₂CF(CF₃))—, or the like, and is preferably —(OCF₂CF₂CF₂CF₂CF₂CF₂)—. For example, —(OC₅F₁₀)— may be —(OCF₂CF₂CF₂CF₂CF₂)—, —(OCF(CF₃)CF₂CF₂CF₂)—, —(OCF₂CF(CF₃)CF₂CF₂)—, —(OCF₂CF₂CF(CF₃)CF₂)—, or —(OCF₂CF₂CF₂CF(CF₃))—, and is preferably —(OCF₂CF₂CF₂CF₂CF₂)—. For example, —(OC₄F₈)— may be any of —(OCF₂CF₂CF₂CF₂)—, —(OCF(CF₃)CF₂CF₂)—, —(OCF₂CF(CF₃)CF₂)—, —(OCF₂CF₂CF(CF₃))—, —(OC(CF₃)₂CF₂)—, —(OCF₂C(CF₃)₂)—, —(OCF(CF₃)CF(CF₃))—, —(OCF(C₂F₅)CF₂)— and —(OCF₂CF(C₂F₅))—, and is preferably —(OCF₂CF₂CF₂CF₂)—. For example, —(OC₃F₆)— may be any of —(OCF₂CF₂CF₂)—, —(OCF(CF₃)CF₂)— and —(OCF₂CF(CF₃))—, and is preferably —(OCF₂CF₂CF₂)—. For example, —(OC₂F₄)— may be any of —(OCF₂CF₂)— and —(OCF(CF₃))—, and is preferably —(OCF₂CF₂)—.

In one embodiment, PFPE is —(OC₃F₆)_{d}—: wherein d is an integer of 1 or more and 200 or less, preferably 5 or more and 200 or less, more preferably 10 or more and 200 or less. PFPE is preferably —(OCF₂CF₂CF₂)_{d}—: wherein d is an integer of 1 or more and 200 or less, preferably 5 or more and 200 or less, more preferably 10 or more and 200 or less; or —(OCF(CF₃)CF₂)_{d}—: wherein d is an integer of 1 or more and 200 or less, preferably 5 or more and 200 or less, more preferably 10 or more and 200 or less. PFPE is more preferably —(OCF₂CF₂CF₂)_{d}—: wherein d is an integer of 1 or more and 200 or less, preferably 5 or more and 200 or less, more preferably 10 or more and 200 or less.

In another embodiment, PFPE is —(OC₄F₈)_{c}—(OC₃F₆)_{d}—(OC₂F₄)ₑ—(OCF₂)_{f}—: wherein c and d are each independently an integer of 0 or more and 30 or less, e and f are each independently an integer of 1 or more and 200 or less, preferably 5 or more and 200 or less, more preferably 10 or more and 200 or less, the sum of c, d, e and f is an integer of at least 5 or more, preferably 10 or more, more preferably 10 or more and 200 or less, and the occurrence order of respective repeating units in parentheses with a subscript c, d, e or f is not limited in the formula. PFPE is preferably —(OCF₂CF₂CF₂CF₂)_{c}—(OCF₂CF₂CF₂)_{d}—(OCF₂CF₂)ₑ—(OCF₂)_{f}—. In one embodiment, for example, PFPE may be —(OC₂F₄)ₑ—(OCF₂)_{f}—: wherein e and f are each independently an integer of 1 or more and 200 or less, preferably 5 or more and 200 or less, more preferably 10 or more and 200 or less, and the occurrence order of respective repeating units in parentheses with a subscript e or f is not limited in the formula.

In still another embodiment, PFPE is a group represented by —(R⁶—R⁷)ⱼ—. In the formula, R⁶ is OCF₂ or OC₂F₄, preferably OC₂F₄. In the formula, R⁷ is a group selected from OC₂F₄, OC₃F₆, OC₄F₈, OC₅F₁₀ and OC₆F₁₂, or a combination of two or three groups independently selected from these groups. R⁷ is preferably a group selected from OC₂F₄, OC₃F₆ and OC₄F₈, a group selected from OC₃F₆, OC₄F₈, OC₅F₁₀ and OC₆F₁₂, or a combination of two or three groups independently selected from these groups. The combination of two or three groups independently selected from OC₂F₄, OC₃F₆ and OC₄F₈ is not limited, and examples thereof include —OC₂F₄OC₃F₆—, —OC₂F₄OC₄F₈—, —OC₃F₆OC₂F₄—, —OC₃F₆OC₃F₆—, —OC₃F₆OC₄F₈—, —OC₄F₈OC₄F₈—, —OC₄F₈OC₃F₆—, —OC₄F₈OC₂F₄—, —OC₂F₄OC₂F₄OC₃F₆—, —OC₂F₄OC₂F₄OC₄F₈—, —OC₂F₄OC₃F₆OC₂F₄—, —OC₂F₄OC₃F₆OC₃F₆—, —OC₂F₄OC₄F₈OC₂F₄—, —OC₃F₆OC₂F₄OC₂F₄—, —OC₃F₆OC₂F₄OC₃F₆—, —OC₃F₆OC₃F₆OC₂F₄—, and —OC₄F₈OC₂F₄OC₂F₄—. j is an integer of 2 or more, preferably 3 or more, more preferably 5 or more, and 100 or less, preferably 50 or less. j is, for example, an integer of 2 to 100, specifically an integer of 2 to 50. In the formulae, for example, OC₂F₄, OC₃F₆, OC₄F₈, OC₅F₁₀ and OC₆F₁₂ may be linear or branched, and are preferably linear. In this embodiment, PFPE is preferably —(OC₂F₄—OC₃F₆)ⱼ— or —(OC₂F₄—OC₄F₈)ⱼ—.

The ratio of e to f (hereinafter, “e/f ratio”) in PFPE is 0.1 or more and 10 or less, preferably 0.2 or more and 5.0 or less, more preferably 0.2 or more and 2.0 or less, further preferably 0.2 or more and 1.5 or less, particularly preferably 0.2 or more and 0.85 or less. When the e/f ratio is 10 or less, lubricity, friction durability and chemical resistance (for example, durability to artificial sweat) of a surface-treating layer obtained from the compound are more enhanced. As the e/f ratio is lower, lubricity and friction durability of the surface-treating layer are more enhanced. On the other hand, when the e/f ratio is 0.1 or more, stability of the compound can be more enhanced. As the e/f ratio is higher, stability of the compound is more enhanced.

In the formulae (A1) and (A2), X represents a substituted or unsubstituted alkylene group having 2 to 20 carbon atoms. The alkylene group refers to a group having a —(C_{α}H_{2α})— structure. In X, α is an integer of 2 to 20. For example, the alkylene group may be linear or branched, and is preferably linear. The number of carbon atoms is preferably 2 to 10, more preferably 2 to 5. For example, the alkylene group may be substituted with a substituent such as a halogen atom. The alkylene group is preferably unsubstituted. A specific example of the alkylene group is an unsubstituted alkylene group having 2 to 10 carbon atoms (preferably 2 to 5 carbon atoms), in particular, an unsubstituted linear alkylene group having 2 to 10 carbon atoms (preferably 2 to 5 carbon atoms). X is understood to be a linker for linking a perfluoropolyether moiety (Rf-PFPE moiety or -PFPE-moiety) that mainly provides water-repellency and surface lubricity, to a silane moiety (—SiR^{a}ₖR^{b}ₗR^{c}ₘ moiety) that is to be hydrolyzed to provide a binding ability to a base material, in any compound represented by the formulae (A1) and (A2). It is presumed that, when X has such a structure, the bond energy at the linker moiety can be higher than that at a linker moiety having an ether bond or an amide bond, resulting in an enhancement in UV resistance of a surface-treating layer formed. Furthermore, the PFPE-containing silane compound of the present invention can contribute to formation of a surface-treating layer having favorable UV resistance even when it is repeatedly irradiated with UV. UV resistance can be evaluated by, for example, measurement of the change in physical properties (for example, contact angle) of a surface-treating layer formed, before and after UV irradiation, as described below.

The PFPE-containing silane compound of the present invention can have the above structure of X, thereby contributing to formation of a surface-treating layer having chemical durability (for example, being hardly degraded even under an acid and/or alkaline environment, more specifically, an environment where sweat may be attached more easily). The PFPE-containing silane compound of the present invention can have the above structure of X, thereby contributing to formation of a surface-treating layer favorable in friction durability, in particular, contributing to formation of a surface-treating layer enhanced in friction resistance even under an environment easily exposed to an acid and/or alkaline environment.

In the formulae (A1) and (A2), R^{a} represents, each independently at each occurrence, —Z—SiR¹ₚR²_{q}R³ᵣ.

In the formulae, Z represents, each independently at each occurrence, an oxygen atom or a divalent organic group.

Z is preferably a divalent organic group, and does not include a group which forms a siloxane bond together with a Si atom (Si atom to which R^{a} is bound) present in a terminal of the molecular backbone in the formula (A1) or (A2).

Z is preferably an alkylene group, —(CH₂)_{g}—O—(CH₂)ₕ—: wherein g is an integer of 1 to 6 and h is an integer of 1 to 6; or -phenylene-(CH₂)ᵢ—: wherein i is an integer of 0 to 6. For example, such groups may be substituted with, for example, one or more substituents selected from a fluorine atom, a C₁₋₆ alkyl group, a C₂₋₆ alkenyl group, and a C₂₋₆ alkynyl group. Z is more preferably a linear or branched alkylene group, further preferably a linear alkylene group from the viewpoint of particularly favorable UV resistance. The number of carbon atom(s) forming the alkylene group in Z is preferably in the range from 1 to 8, more preferably in the range from 1 to 6, further preferably in the range from 1 to 3. The alkylene group is as described above.

Z is preferably an alkylene group, —(CH₂)_{g}—O—(CH₂)ₕ—: wherein g is an integer of 1 to 6 and h is an integer of 1 to 6; or -phenylene-(CH₂)ᵢ—: wherein i is an integer of 0 to 6. For example, such groups may be substituted with, for example, one or more substituents selected from a fluorine atom, a C₁₋₆ alkyl group, a C₂₋₆ alkenyl group, and a C₂₋₆ alkynyl group. Z is more preferably a linear or branched alkylene group, further preferably a linear alkylene group from the viewpoint of particularly favorable UV resistance. The number of carbon atom(s) forming the alkylene group in Z is preferably in the range from 1 to 6, more preferably in the range from 1 to 3. The alkylene group is as described above.

In the formulae, R¹ represents, each independently at each occurrence, R^{a′}. R^{a′} has the same definition as R^{a}.

The number of Si atoms linearly linked via the Z group in R^{a} is up to 5. That is, when at least one R¹ is present in R^{a}, the number of Si atoms linearly linked via the Z group in R^{a} is 2 or more, and the number of Si atoms linearly linked via the Z group is up to 5. Herein, “the number of Si atoms linearly linked via the Z group in R^{a}” is equal to the number of repeating units of —Z—Si— linearly linked in R^{a}.

One example where Si atoms are, for example, linked via the Z group in R^{a} is shown below.

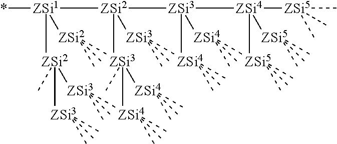

In the formula, “*” means a moiety bonding to Si of the backbone, and “ . . . ” means that a predetermined group other than ZSi is bound, namely, means a point at which repeating of ZSi is terminated when all three bonds of Si atom correspond to “ . . . ”. The number on the right shoulder of Si means the number of occurrences of Si linearly linked via the Z group from *. That is, a chain in which the repeat of ZSi is completed at Si² means that the “number of Si atoms linearly linked via the Z group in R^{a}” is 2, and, similarly, a chain in which the repeat of ZSi is completed at Si³, Si⁴ or Si⁵ means that the “number of Si atoms linearly linked via the Z group in R^{a}” is 3, 4 or 5, respectively. While a plurality of ZSi chains are present in R^{a} as is clear from the above formula, all the chains do not necessarily have the same length, and may each have any length.

In a preferable embodiment, the “number of Si atoms linearly linked via the Z group in R^{a}” is 1 (left formula) or 2 (right formula) in all chains, as described below.

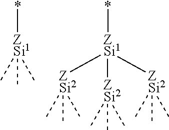

In one embodiment, the number of Si atoms linearly linked via the Z group in R^{a} is 1 or 2, preferably 1.

In the formulae, R² represents, each independently at each occurrence, a hydroxyl group or a hydrolyzable group.

The “hydrolyzable group”, as used herein, means a group that can be removed from the main backbone of the compound by a hydrolysis reaction. Examples of the hydrolyzable group include —OR, —OCOR, —O—N═CR₂, —NR₂, —NHR and halogen (wherein R represents a substituted or unsubstituted alkyl group having 1 to 4 carbon atoms), and the hydrolyzable group is preferably —OR (namely, alkoxy group). Examples of R include unsubstituted alkyl groups such as a methyl group, an ethyl group, a propyl group, an isopropyl group, a n-butyl group and an isobutyl group; and substituted alkyl groups such as a chloromethyl group. Among them, an alkyl group, in particular, an unsubstituted alkyl group is preferable, and a methyl group or an ethyl group is more preferable. The hydroxyl group is not limited, and, for example, may be generated by hydrolysis of the hydrolyzable group.

R² preferably represents —OR: wherein R represents a substituted or unsubstituted C₁₋₃ alkyl group, more preferably a methyl group.

In the formulae, R³ represents, each independently at each occurrence, a hydrogen atom or a lower alkyl group. The lower alkyl group is preferably an alkyl group having 1 to 20 carbon atoms, more preferably an alkyl group having 1 to 6 carbon atoms, further preferably a methyl group.

In the formulae, p is, each independently at each occurrence, an integer of 0 to 3; q is, each independently at each occurrence, an integer of 0 to 3; and r is, each independently at each occurrence, an integer of 0 to 3, provided that the sum of p, q and r in each —Z—SiR¹ₚR²_{q}R³ᵣ is 3.

In a preferable embodiment, q in R^{a}′ (or R^{a} when R^{a}′ is absent) at a terminal in R^{a} preferably 2 or more, for example, 2 or 3, more preferably 3.

In a preferable embodiment, R^{a} can have at least one —Si(—Z—SiR²_{q}R³ᵣ)₂ or —Si(—Z—SiR²_{q}R³ᵣ)₃, preferably —Si(—Z—SiR²_{q}R³ᵣ)₃, at a terminal portion. In the formula, the (—Z—SiR²_{q}R³ᵣ) unit is preferably (—Z—SiR²₃). In a still preferable embodiment, all terminal portions of R^{a} can be —Si(—Z—SiR²_{q}R³ᵣ)₃, preferably —Si(—Z—SiR²₃)₃.

In the formulae (A1) and (A2), two or more Si atoms having at least one R² are present. The PFPE-containing silane compound of the present invention can have such a structure to thereby allow for formation of a surface-treating layer that can be favorably bound to a base material surface or the like.

In the formulae, R^{b} represents, each independently at each occurrence, a hydroxyl group or a hydrolyzable group.

R^{b} is preferably a hydroxyl group, —OR, —OCOR, —O—N═C(R)₂, —N(R)₂, —NHR or halogen (wherein R represents a substituted or unsubstituted alkyl group having 1 to 4 carbon atoms), preferably —OR. Examples of R include unsubstituted alkyl groups such as a methyl group, an ethyl group, a propyl group, an isopropyl group, a n-butyl group and an isobutyl group; and substituted alkyl groups such as a chloromethyl group. Among them, an alkyl group, in particular, an unsubstituted alkyl group is preferable, and a methyl group or an ethyl group is more preferable. The hydroxyl group is not limited, and, for example, may be generated from the hydrolyzable group by hydrolysis. R^{c} is more preferably —OR; wherein R represents a substituted or unsubstituted C₁₋₃ alkyl group, more preferably a methyl group.

In the formulae, R^{c} represents, each independently at each occurrence, a hydrogen atom or a lower alkyl group. The lower alkyl group is preferably an alkyl group having 1 to 20 carbon atoms, more preferably an alkyl group having 1 to 6 carbon atoms, further preferably a methyl group.

In the formulae, k is, each independently at each occurrence, an integer of 1 to 3; 1 is, each independently at each occurrence, an integer of 0 to 2; m is, each independently at each occurrence, an integer of 0 to 2, provided that the sum of k, l and m in each —SiR^{a}ₖR^{b}ₗR^{c}ₘ is 3; and k is preferably 3.

In the PFPE-containing silane compound represented by the formula (A1) or (A2), the average molecular weight of the Rf-PFPE-moiety is not limited, and is 500 to 30,000, preferably 1,500 to 30,000, more preferably 2,000 to 10,000.

In another embodiment, the number average molecular weight of the Rf-PFPE moiety is 500 to 30,000, preferably 1,000 to 20,000, more preferably 2,000 to 15,000.

In another embodiment, the number average molecular weight of the Rf-PFPE-moiety or the -PFPE-moiety can be 4,000 to 30,000, preferably 5,000 to 10,000.

The PFPE-containing silane compound of the present invention represented by the formula (A1) or (A2) is not limited, and can have an average molecular weight of 5×10² to 1×10⁵. In particular, the PFPE-containing silane compound preferably has an average molecular weight of 2,000 to 30,000, more preferably 2,500 to 12,000, from the viewpoint of friction durability. In the present invention, the “average molecular weight” refers to a number average molecular weight, and the “average molecular weight” is defined as a value obtained by ¹⁹F-NMR measurement.

In a preferable embodiment, in the PFPE-containing silane compound of the present invention represented by the formula (A1) or (A2),

Rf is a perfluoroalkyl group having 1 to 16 carbon atoms;

PFPE is represented by the following formula (a), (b) or (c):

—(OC₃F₆)_{d}— (a)

wherein d is an integer of 1 or more and 200 or less;

—(OC₄F₈)_{c}—(OC₃F)_{d}—(OC₂F₄)ₑ—(OCF₂)_{f}— (b)

wherein c and d are each independently an integer of 0 or more and 30 or less;

e and f are each independently an integer of 1 or more and 200 or less;

the sum of c, d, e and f is an integer of 10 or more and 200 or less; and

the occurrence order of respective repeating units in parentheses with a subscript c, d, e or f is not limited in the formula;

—(R⁶—R⁷)ⱼ— (c)

wherein R⁶ is OCF₂ or OC₂F₄;

R⁷ is a group selected from OC₂F₄, OC₃F₆, OC₄F₈, OC₅F₁₀ and OC₆F₁₂, or a combination of two or three groups selected therefrom; and

j is an integer of 2 to 100;

X is an unsubstituted linear alkylene group having 2 to 10 carbon atoms;

R^{a} represents, each independently at each occurrence, —Z—SiR¹ₚR²_{q}R³ᵣ;

Z represents, each independently at each occurrence, an oxygen atom or a divalent organic group;

R² represents, each independently at each occurrence, a hydroxyl group or a hydrolyzable group;

q is 3; and

k is 3.

Any compound represented by the formulae (A1) and (A2) can be obtained by, for example, introducing a hydroxyl group to a terminal, with a perfluoropolyether derivative corresponding to the Rf-PFPE-moiety, as a raw material, then introducing a group having an unsaturated bond, to a terminal, reacting the group having an unsaturated bond and a silyl derivative having a halogen atom, further introducing a hydroxyl group to a terminal of the silyl group, and reacting the group having an unsaturated bond introduced and the silyl derivative. For example, the compound can be synthesized as described in International Publication No. WO2014/069592.

Next, the surface-treating agent of the present invention will be described.

The surface-treating agent of the present invention contains at least one PFPE-containing silane compound represented by the formula (A1) and/or formula (A2). The PFPE-containing silane compound is as described above.

The surface-treating agent of the present invention can impart water-repellency, oil-repellency, antifouling property, friction durability, and UV resistance to a base material, is not limited, and can be suitably used as an antifouling coating agent.

For example, the surface-treating agent of the present invention may be diluted with a solvent. Such a solvent is not limited, and examples thereof include:

any fluorine atom-containing solvent selected from the group consisting of perfluorohexane, CF₃CF₂CHCl₂, CF₃CH₂CF₂CH₃, CF₃CHFCHFC₂F₅, 1,1,1,2,2,3,3,4,4,5,5,6,6-tridecafluorooctane, 1,1,2,2,3,3,4-heptafluoro cyclopentane ((Zeorora H (trade name) and the like), C₄F₉OCH₃, C₄F₉OC₂H₅, CF₃CH₂OCF₂CHF₂, C₆F₁₃CH═CH₂, xylene hexafluoride, perfluorobenzene, methyl pentadecafluoroheptyl ketone, trifluoroethanol, pentafluoropropanol, hexafluoroisopropanol, HCF₂CF₂CH₂OH, methyl trifluoromethanesulfonate, trifluoroacetic acid and CF₃O(CF₂CF₂O)ₘ₁(CF₂O)ₙ₁CF₂CF₃: wherein m1 and n1 are each independently an integer of 0 or more and 1000 or less, and the occurrence order of respective repeating units in parentheses with a symbol m1 or n1 is not limited in the formula, provided that the sum of m1 and n1 is 1 or more; 1,1-dichloro-2,3,3,3-tetrafluoro-1-propene, 1,2-dichloro-1,3,3,3-tetrafluoro-1-propene, 1,2-dichloro-3,3,3-trifluoro-1-propene, 1,1-dichloro-3,3,3-trifluoro-1-propene, 1,1,2-trichloro-3,3,3-trifluoro-1-propene, and 1,1,1,4,4,4-hexafluoro-2-butene.

The water content in the solvent is preferably 20 ppm or less in terms of the mass. The water content can be measured by use of the Karl Fischer method. The water content can be within the range, thereby resulting in an enhancement in storage stability of the surface-treating agent.

For example, the surface-treating agent including the PFPE-containing silane compound of the present invention may include other components in addition to the PFPE-containing silane compound. Such other components are not limited, and examples thereof include other surface treatment compounds, a (non-reactive) fluoropolyether compound that can be understood as a fluorine-containing oil, preferably a perfluoro(poly)ether compound (hereinafter, referred to as “fluorine-containing oil”), a (non-reactive) silicone compound (hereinafter, referred to as “silicone oil”) that can be understood as a silicone oil, an alcohol, a catalyst, a transition metal, a halide ion, and a compound containing an atom having an unshared electron pair in a molecular structure.

Such other surface treatment compounds are not limited, and examples thereof include at least one perfluoro(poly)ether group-containing silane compound represented by any of the following general formulae (1A), (2A), (1B), (2B), (1C), (2C), (1D) and (2D):

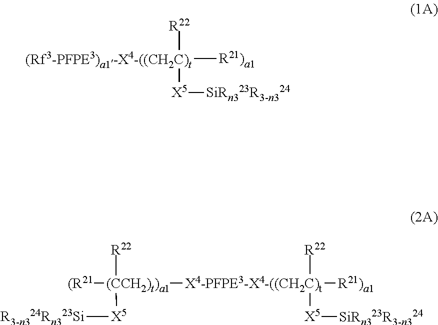

(Rf³-PFPE³)_{β1′}-X⁶—(SiR²³ₙ₃R²⁴₃₋ₙ₃)_{β1} (1B)

(R²⁴₃₋ₙ₃R²³ₙ₃Si)_{β1}—X⁶-PFPE³-X⁶—(SiR²³ₙ₃R²⁴₃₋ₙ₃)_{β1} (2B)

(Rf³-PFPE³)_{γ1′}-X⁷—(SiR^{a3}ₖ₁R^{b3}ₗ₁R^{c3}ₘ₁)_{γ1} (1C)

(R^{c3}ₘ₁R^{b3}ₗ₁Si)_{γ1}—X⁷-PFPE³-X⁷—(SiR^{a3}ₖ₁R^{b3}ₗ₁R^{c3}ₘ₁)_{γ1} (2C)

(Rf³-PFPE³)_{δ1′}-X⁹—(CR^{d3}ₖ₂R^{e3}ₗ₂R^{f3}ₘ₂)_{δ1} (1D)

(R^{f3}ₘ₂R^{e3}ₗ₂R^{d3}ₖ₂C)_{δ1}—X⁹-PFPE³-X⁹—(CR^{d3}ₖ₂R^{e3}ₗ₂R^{f3}ₘ₂)_{δ1} (2D)

wherein:

PFPE³ represents, each independently at each occurrence, a group represented by formula:

—(OC₆F₁₂)ₐ₁—(OC₅F₁₀)_{b1}—(OC₄F₈)_{c1}—(OC₃F₆)_{d1}—(OC₂F₄)ₑ₁—(OCF₂)_{f1}—

wherein a1, b1, c1, d1, e1 and f1 are each independently an integer of 0 or more and 200 or less, the sum of a1, b1, c1, d1, e1 and f1 is at least 1, and the occurrence order of respective repeating units in parentheses with a symbol a1, b1, c1, d1, e1 or f1 is not limited in the formula;

Rf³ represents, each independently at each occurrence, an alkyl group having 1 to 16 carbon atoms, optionally substituted with one or more fluorine atoms;

R²³ represents, each independently at each occurrence, a hydroxyl group or a hydrolyzable group;

R²⁴ represents, each independently at each occurrence, a hydrogen atom or an alkyl group having 1 to 22 carbon atoms;

R²¹ represents, each independently at each occurrence, a hydrogen atom or a halogen atom;

R²² represents, each independently at each occurrence, a hydrogen atom or a lower alkyl group;

n3 is independently an integer of 0 to 3 per unit (—SiR²³ₙ₃R²⁴₃₋ₙ3)

provided that at least one n3 is an integer of 1 to 3 in the formulae (1A), (2A), (1B) and (2B);

X⁴ represents, each independently, a single bond or a 2-10 valent organic group;

X⁵ represents, each independently at each occurrence, a single bond or a divalent organic group;

t represents, each independently at each occurrence, an integer of 1 to 10;

α1 is each independently an integer of 1 to 9;

α1′ is each independently an integer of 1 to 9;

X⁶ represents, each independently, a single bond or a 2-10 valent organic group;

β1 is each independently an integer of 1 to 9;

β1′ is each independently an integer of 1 to 9;

X⁷ represents, each independently, a single bond or a 2-10 valent organic group;

γ1 is each independently an integer of 1 to 9;

γ1′ is each independently an integer of 1 to 9;

R^{a3} represents, each independently at each occurrence, —Z³—SiR⁷¹ₚ₁R⁷²_{q1}R⁷³ᵣ₁;

Z³ represents, each independently at each occurrence, an oxygen atom or a divalent organic group;

R⁷¹ represents, each independently at each occurrence, R^{a3′;}

R^{a3′} has the same definition as R^{a3};

the number of Si atoms linearly linked via Z³ group in R^{a3} is up to 5;

R⁷² represents, each independently at each occurrence, a hydroxyl group or a hydrolyzable group;

R⁷³ represents, each independently at each occurrence, a hydrogen atom or a lower alkyl group;

p1 is, each independently at each occurrence, an integer of 0 to 3;

q1 is, each independently at each occurrence, an integer of 0 to 3;

r1 is, each independently at each occurrence, an integer of 0 to 3;

provided that at least one q1 in the formulae (1C) and (2C) is an integer of 1 to 3;

R^{b3} represents, each independently at each occurrence, a hydroxyl group or a hydrolyzable group;

R^{c3} represents, each independently at each occurrence, a hydrogen atom or a lower alkyl group;

k1 is, each independently at each occurrence, an integer of 1 to 3;

l1 is, each independently at each occurrence, an integer of 0 to 2;

m1 is, each independently at each occurrence, an integer of 0 to 2;

X⁹ represents, each independently, a single bond or a 2-10 valent organic group;

δ1 is each independently an integer of 1 to 9;

δ1′ is each independently an integer of 1 to 9;

R^{d3} represents, each independently at each occurrence, —Z₄—CR⁸¹ₚ₂R⁸²_{q2}R⁸³ᵣ₂;

Z⁴ represents, each independently at each occurrence, an oxygen atom or a divalent organic group;

R⁸¹ represents, each independently at each occurrence, R^{d3′};

R^{d3′} has the same definition as R^{d3};

The number of C atoms linearly linked via Z⁴ group in R^{d3} is up to 5;

R⁸² represents, each independently at each occurrence, —Y—SiR⁸⁵ₙ₂R⁸³₃₋ₙ₂;

Y represents, each independently at each occurrence, a divalent organic group;

R⁸⁵ represents, each independently at each occurrence, a hydroxyl group or a hydrolyzable group;

R⁸⁶ represents, each independently at each occurrence, a hydrogen atom or a lower alkyl group;

n2 independently represents an integer of 1 to 3 per unit (—Y—SiR⁸⁵ₙ₂R⁸⁶₃₋ₙ2);

provided that at least one n2 in the formulae (1D) and (2D) is an integer of 1 to 3;

R⁸³ represents, each independently at each occurrence, a hydrogen atom or a lower alkyl group;

p2 is, each independently at each occurrence, an integer of 0 to 3;

q2 is, each independently at each occurrence, an integer of 0 to 3;

r2 is, each independently at each occurrence, an integer of 0 to 3;

R^{e3} represents, each independently at each occurrence, —Y—SiR⁸⁵ₙ₂R⁸⁶₃₋ₙ2;

R^{f3} represents, each independently at each occurrence, a hydrogen atom or a lower alkyl group;

k2 is, each independently at each occurrence, an integer of 0 to 3;

l2 is, each independently at each occurrence, an integer of 0 to 3; and

m2 is, each independently at each occurrence, an integer of 0 to 3;

provided that at least one q2 is 2 or 3 or at least one 12 is 2 or 3, in the formulae (1D) and (2D).

The fluorine-containing oil is not limited, and examples thereof include a compound (perfluoro(poly)ether compound) represented by the following general formula (3):

Rf⁵—(OC₄F₈)_{a′}—(OC₃F₆)_{b′}—(OC₂F₄)_{c′}—(OCF₂)_{d′}—Rf⁶ (3)

In the formula, Rf⁵ represents an alkyl group having 1 to 16 carbon atoms (preferably C₁₋₁₆ perfluoroalkyl group), optionally substituted with one or more fluorine atoms, Rf⁶ represents an alkyl group having 1 to 16 carbon atoms (preferably C₁₋₁₆ perfluoroalkyl group), optionally substituted with one or more fluorine atoms, a fluorine atom, or a hydrogen atom, and Rf⁵ and Rf⁶ more preferably each independently are a C₁₋₃ perfluoroalkyl group;

In the formula, a′, b′, c′ and d′ represent the numbers of the four repeating units of perfluoro(poly)ether which contribute a main backbone of the polymer, respectively, and are, independently of each other, an integer of 0 or more and 300 or less, and the sum of a′, b′, c′ and d′ is at least 1, preferably 1 to 300, more preferably 20 to 300. The occurrence order of respective repeating units in parentheses with a subscript a′, b′, c′ or d′ is not limited in the formula. In these repeating units, —(OC₄F₈)— may be any of —(OCF₂CF₂CF₂CF₂)—, —(OCF(CF₃)CF₂CF₂)—, —(OCF₂CF(CF₃)CF₂)—, —(OCF₂CF₂CF(CF₃))—, —(OC(CF₃)₂CF₂)—, —(OCF₂C(CF₃)₂)—, —(OCF(CF₃)CF(CF₃))—, —(OCF(C₂F₅)CF₂)— and —(OCF₂CF(C₂F₅))—, and is preferably —(OCF₂CF₂CF₂CF₂)—; —(OC₃F₆)— may be any of —(OCF₂CF₂CF₂)—, —(OCF(CF₃)CF₂)— and —(OCF₂CF(CF₃))—, and is preferably —(OCF₂CF₂CF₂)—; and —(OC₂F₄)— may be any of —(OCF₂CF₂)— and —(OCF(CF₃))—, and is preferably —(OCF₂CF₂)—.

Examples of the perfluoro(poly)ether compound represented by the general formula (3) include a compound (for example, which may be a single compound or a combination of two or more kinds) represented by any of the following general formulae (3a) and (3b):

Rf⁵—(OCF₂CF₂CF₂)_{b″}—Rf⁶ (3a)

Rf⁵—(OCF₂CF₂CF₂CF₂)_{a″}—(OCF₂CF₂CF₂)_{b″}—(OCF₂CF₂)_{c″}—(OCF₂)_{d″}—Rf⁶ (3b)

In the formulae, Rf⁵ and Rf⁶ are as described above; b″ is an integer of 1 or more and 100 or less in the formula (3a); and a″ and b″ are each independently an integer of 1 or more and 30 or less, and c″ and d″ are each independently an integer of 1 or more and 300 or less, in the formula (3b). The occurrence order of respective repeating units in parentheses with a subscript a″, b″, c″, or d″ is not limited in the formula.

For example, the fluorine-containing oil may have an average molecular weight of 1,000 to 30,000. Thus, high surface lubricity can be obtained.

The content of the fluorine-containing oil in the surface-treating agent of the present invention can be, for example, 0 to 500 parts by mass, preferably 0 to 400 parts by mass, more preferably 5 to 300 parts by mass with respect to 100 parts by mass of the perfluoro(poly)ether group-containing silane compound (when two or more kinds of such oils are contained, the content means the total content of such oils, hereinafter the same shall apply).

For example, the compound represented by the general formula (3a) and the compound represented by the general formula (3b) may be each used singly or in combinations of two or more kinds. The compound represented by the general formula (3b) is more preferably used than the compound represented by the general formula (3a) because higher surface lubricity is obtained. When these compounds are used in a combination, the mass ratio of the compound represented by the general formula (3a) to the compound represented by the general formula (3b) is preferably 1:1 to 1:30, more preferably 1:1 to 1:10. When the mass ratio is within the range, a surface-treating layer satisfying surface lubricity and friction durability in a well-balanced manner can be obtained.

In one embodiment, the fluorine-containing oil includes at least one compound represented by the general formula (3b). In such an embodiment, the mass ratio of the total of the perfluoro(poly)ether group-containing silane compound to the compound represented by the formula (3b) in the surface-treating agent is preferably 10:1 to 1:10, still more preferably 4:1 to 1:4.

In one embodiment, the average molecular weight of the compound represented by the formula (3a) is preferably 2,000 to 8,000.

In one embodiment, the average molecular weight of the compound represented by the formula (3b) is preferably 8,000 to 30,000.

In another embodiment, the average molecular weight of the compound represented by the formula (3b) is preferably 3,000 to 8,000.

In a preferable embodiment, when the surface-treating layer is formed according to a vacuum deposition method, for example, the average molecular weight of the fluorine-containing oil may be higher than the average molecular weight of the perfluoro(poly)ether group-containing silane compound. For example, the number average molecular weight of the fluorine-containing oil may be higher than the number average molecular weight of the perfluoro(poly)ether group-containing silane compound by 2,000 or more, preferably 3,000 or more, more preferably 5,000 or more. When these average molecular weights are adopted, more excellent friction durability and surface lubricity can be obtained.

For example, the fluorine-containing oil may be a compound represented by general formula Rf′—F: wherein Rf′ is C₅₋₁₆ perfluoroalkyl group; from another viewpoint.

For example, the fluorine-containing oil may be a chlorotrifluoroethylene oligomer. The compound represented by Rf′—F and the chlorotrifluoroethylene oligomer are preferable because these compounds have high affinity with a perfluoro(poly)ether group-containing silane compound where Rf is a C₁₋₁₆ perfluoroalkyl group.

The fluorine-containing oil contributes to increasing of surface lubricity of the surface-treating layer.

For example, a linear or cyclic silicone oil having 2,000 or less siloxane bonds can be used as the silicone oil. For example, the linear silicone oil may be any of so-called straight silicone oil and modified silicone oil. Examples of the straight silicone oil include dimethyl silicone oils, methyl phenyl silicone oils, and methyl hydrogen silicone oils. Examples of the modified silicone oil include straight silicone oils modified by alkyl, aralkyl, polyether, higher fatty acid ester, fluoroalkyl, amino, epoxy, carboxyl, alcohol, or the like. Examples of the cyclic silicone oil include cyclic dimethyl siloxane oils.

The content of such a silicone oil in the surface-treating agent of the present invention can be, for example, 0 to 300 parts by mass, preferably 0 to 200 parts by mass with respect to 100 parts by mass of the total of the perfluoro(poly)ether group-containing silane compound and the carboxylate ester compound (when two or more kinds of such oils are contained, the content means the total content of such oils, hereinafter the same shall apply).

The silicone oil contributes to increasing of the surface lubricity of the surface-treating layer.

Examples of the catalyst include acids (for example, acetic acid and trifluoroacetic acid), bases (for example, ammonia, triethylamine, and diethylamine), and transition metals (for example, Ti, Ni, and Sn).

The catalyst promotes hydrolysis and dehydration condensation of the perfluoro(poly)ether group-containing silane compound, and promotes formation of the surface-treating layer.

Examples of the transition metals include platinum, ruthenium, and rhodium.

Examples of the halide ions include chloride ions.

The compound containing an atom having an unshared electron pair in a molecular structure preferably contains at least one atom selected from the group consisting of a nitrogen atom, an oxygen atom, a phosphorus atom, and a sulfur atom, more preferably a sulfur atom or a nitrogen atom.

The compound containing an atom having an unshared electron pair in a molecular structure preferably contains at least one functional group selected from the group consisting of an amino group, an amide group, a sulfinyl group, a P═O group, a S═O group, and a sulfonyl group, more preferably at least one functional group selected from the group consisting of a P═O group, and a S═O group, in a molecular structure.

The compound containing an atom having an unshared electron pair in a molecular structure is preferably at least one compound selected from the group consisting of an aliphatic amine compound, an aromatic amine compound, an amide phosphate compound, an amide compound, a urea compound, and a sulfoxide compound, more preferably at least one compound selected from the group consisting of an aliphatic amine compound, an aromatic amine compound, amide phosphate, a urea compound, and a sulfoxide compound, particularly preferably at least one compound selected from the group consisting of a sulfoxide compound, an aliphatic amine compound and an aromatic amine compound, further preferably a sulfoxide compound. Examples of the aliphatic amine compound can include diethylamine and triethylamine. Examples of the aromatic amine compound can include aniline and pyridine.

Examples of the amide phosphate compound can include hexamethylphosphoramide. Examples of the amide compound can include N,N-diethylacetamide, N,N-diethylformamide, N,N-dimethylacetamide, N-methylformamide, N,N-dimethylformamide, and N-methylpyrrolidone. Examples of the urea compound can include tetramethylurea. Examples of the sulfoxide compound can include dimethylsulfoxide (DMSO), tetramethylenesulfoxide, methylphenylsulfoxide, and diphenylsulfoxide. Among these compounds, dimethylsulfoxide or tetramethylenesulfoxide is preferably used.

Examples of any component other than the above also include tetraethoxysilane, methyltrimethoxysilane, 3-aminopropyltrimethoxysilane, 3-glycidoxypropyltrimethoxysilane, and methyltriacetoxysilane.

Examples of any component other than the above include an alcohol compound having 1 to 6 carbon atoms.

The surface-treating agent of the present invention is impregnated into a porous material such as a porous ceramic material, or a metal fiber that obtained by solidifying a steel wool to obtain a pellet. The pellet can be used, for example, in vacuum deposition.

The surface-treating agent of the present invention is suitably used as a surface-treating agent because it can impart water-repellency, oil-repellency, antifouling property, waterproof property, high friction durability, and UV resistance to a base material. Specifically, the surface-treating agent of the present invention is not limited, and can be suitably used as an antifouling coating agent or a water-proof coating agent.

Next, the article of the present invention will be described.

The article of the present invention includes a base material, and a layer (surface-treating layer) formed from the PFPE-containing silane compound or the surface-treating agent of the present invention (hereinafter, representatively simply referred to as “the surface-treating agent of the present invention”), on a surface of the base material. The article can be produced as follows, for example.

First, a base material is prepared. For example, the base material usable in the present invention may be formed from, for example, any suitable material such as glass, a resin (for example, which may be a natural or synthetic resin such as a general plastic material, and may be in the form of a plate, a film or the like), a metal (for example, which may be a metal itself, such as aluminum, copper, or iron, or a composite such as an alloy), ceramics, a semiconductor (silicon, germanium, or the like), a fiber (woven fabric, unwoven cloth, or the like), fur, leather, a wood material, a pottery, a stone material, or a building component.

The glass is preferably sapphire glass, soda lime glass, alkali aluminosilicate glass, borosilicate glass, alkali-free glass, crystal glass, or quartz glass, particularly preferably soda lime glass chemically reinforced, alkali aluminosilicate glass chemically reinforced, and borosilicate glass chemically bound.

The resin is preferably an acrylic resin, polycarbonate, or the like.

For example, when the article to be produced is an optical member, for example, the material composing the surface of the base material may be a material for optical members, such as glass or transparent plastic. When the article to be produced is an optical member, for example, any layer (or film) such as a hard coating layer or an antireflection layer may be formed on the surface (outermost layer) of the base material. As the antireflection layer, either a monolayer antireflection layer or a multilayer antireflection layer may be used. Examples of an inorganic substance usable for the antireflection layer include SiO₂, SiO, ZrO₂, TiO₂, TiO, Ti₂O₃, Ti₂O₅, Al₂O₃, Ta₂O₅, CeO₂, MgO, Y₂O₃, SnO₂, MgF₂, and WO₃. Such inorganic substances may be used singly or in combinations (for example, as a mixture) of two or more kinds thereof. When a multilayer antireflection layer is formed, SiO₂ and/or SiO are/is preferably used for the outermost layer. When the article to be produced is an optical glass component for a touch panel, the article may have a transparent electrode, for example, a thin film using indium tin oxide (ITO), indium zinc oxide, or the like, on a part of the surface of the base material (glass). The base material may have an insulating layer, an adhesive layer, a protecting layer, a decorated frame layer (I-CON), a sprayed film layer, a hard coating layer, a polarizing film, a phase difference film, and a liquid crystal display module, depending on the specific specifications.

The shape of the base material is not limited. A surface region of the base material, on which the surface-treating layer is to be formed, may be at least a part of the surface of the base material, and can be appropriately determined depending on the intended use, the specific specifications, and the like of the article to be produced.

For example, at least the surface portion of such a base material may be made of a material originally having a hydroxyl group. Examples of such a material include glass, and also include a metal on which a natural oxidized film or a thermal oxidized film is formed (in particular, base metal), ceramics, and a semiconductor. Alternatively, as in a resin, when the hydroxyl group is present but not sufficient, or when the hydroxyl group is originally absent, any pre-treatment of the base material can be conducted to thereby introduce a hydroxyl group onto the surface of the base material or increase the amount of the hydroxyl group on the surface. Examples of such a pre-treatment include a plasma treatment (for example, corona discharge) and ion beam irradiation. A plasma treatment can be suitably utilized in order to not only introduce a hydroxyl group onto the surface of the base material or increase the amount of a hydroxyl group on the surface, but also clean the surface of the base material (remove foreign substances or the like). Other examples of such a pre-treatment include a method where a monolayer of a surface adsorbent having a carbon-carbon unsaturated bond group is previously formed on the surface of the base material by a LB method (Langmuir-Blodgett method) or a chemical adsorption method and thereafter the unsaturated bond is cleaved under an atmosphere containing oxygen, nitrogen, and the like.

Alternatively, such a base material may be that of which at least the surface portion made of a material containing a silicone compound having other reactive group(s) such as one or more Si—H group(s) or alkoxysilane.

Next, a film of the surface-treating agent of the present invention is formed on the surface of such a base material, and is, if necessary, subjected to a post-treatment, and thus the surface-treating layer is formed from the surface-treating agent of the present invention.

The film of the surface-treating agent of the present invention can be formed by applying the surface-treating agent of the present invention onto the surface of the base material so that the surface is coated. The coating method is not limited. For example, a wet coating method and a dry coating method can be used.

Examples of the wet coating method include dip coating, spin coating, flow coating, spray coating, roll coating, gravure coating, and a similar method.

Examples of the dry coating method include deposition (usually vacuum deposition), sputtering, CVD, and a similar method. Specific examples of a deposition method (usually vacuum deposition method) include resistance heating, electron beam, high-frequency heating using microwave or the like, ion beam, and a similar method. Specific examples of a CVD method include plasma-CVD, optical CVD, thermal CVD, and a similar method.

Furthermore, coating by an atmospheric pressure plasma method can also be made.

When the wet coating method is used, the surface-treating agent of the present invention can be diluted with a solvent and then applied to the surface of the base material. The following solvents are preferably used from the viewpoints of stability of the surface-treating agent of the present invention and volatility of such a solvent: C₅₋₁₂ perfluoroaliphatic hydrocarbons (for example, perfluorohexane, perfluoromethyl cyclohexane, and perfluoro-1,3-dimethyl cyclohexane); polyfluoroaromatic hydrocarbons (for example, bis(trifluoromethyl)benzene); polyfluoroaliphatic hydrocarbons (for example, C₆F₁₃CH₂CH₃ (for example, Asahiklin (registered trademark) AC-6000) manufactured by Asahi Glass Co., Ltd. and 1,1,2,2,3,3,4-heptafluoro cyclopentane (for example, Zeorora (registered trademark) H manufactured by Nippon Zeon Co., Ltd.); hydrofluorocarbons (HFC) (for example, 1,1,1,3,3-pentafluorobutane (HFC-365mfc)); hydrochlorofluorocarbons (for example, HCFC-225 (Asahiklin (registered trademark) AK225)); alkyl perfluoroalkyl ethers (perfluoroalkyl group and alkyl group may be linear or branched) such as hydrofluoroethers (HFE) (for example, perfluoropropyl methyl ether (C₃F₇OCH₃) (for example, Novec (trade name) 7000 manufactured by Sumitomo 3M Ltd.), perfluorobutylmethyl ether (C₄F₉OCH₃) (for example, Novec (trade name) 7100 manufactured by Sumitomo 3M Ltd.), perfluorobutylethyl ether (C₄F₉OC₂H₅) (for example, Novec (trade name) 7200 manufactured by Sumitomo 3M Ltd.), and perfluorohexyl methyl ether (C₂F₅CF(OCH₃)C₃F₇) (for example, Novec (trade name) 7300 manufactured by Sumitomo 3M Ltd.), or CF₃CH₂OCF₂CHF₂ (for example, Asahiklin (registered trademark) AE-3000) manufactured by Asahi Glass Co., Ltd.) and 1,2-dichloro-1,3,3,3-tetrafluoro-1-propene (for example, Vertrel (registered trademark) Sion manufactured by Du Pont-Mitsui Fluorochemicals Co., Ltd.). Such solvents may be used singly or as a mixture of two or more kinds combined. Furthermore, for example, such solvents can also be mixed with another solvent in order to adjust the solubility of the perfluoro(poly)ether group-containing silane compound.

When the dry coating method is used, for example, the surface-treating agent of the present invention may be subjected, as it is, to the dry coating method, or may be diluted with the solvent and then subjected to the dry coating method.

Film formation is preferably performed so that the surface-treating agent of the present invention is present together with a catalyst for hydrolysis and dehydration condensation in the film. Briefly, in the case of the wet coating method, for example, the surface-treating agent of the present invention may be diluted with the solvent and thereafter the catalyst may be added to a diluted liquid of the surface-treating agent of the present invention immediately before application to the surface of the base material. In the case of the dry coating method, for example, the surface-treating agent of the present invention, to which the catalyst is added, may be subjected, as it is, to a deposition (usually vacuum deposition) treatment, or may be subjected to a deposition (usually, the vacuum deposition) using a pellet wherein the pellet is obtained by impregnating a porous metal material such as iron or copper with the surface-treating agent of the present invention to which the catalyst has been added.

Any proper acid or base can be used for the catalyst. For example, acetic acid, formic acid, or trifluoroacetic acid can be used as an acid catalyst. For example, ammonia or an organic amine compound can be used as a base catalyst.

Next, the film is subjected to a post-treatment, if necessary. The post-treatment is not limited, and for example, may be performed by sequentially feeding water, and performing drying and heating, and more specifically may be performed as follows.

After the film of the surface-treating agent of the present invention is formed on the surface of the base material as described above, water is supplied to the film (hereinafter, also referred to as “precursor film”). The method of supplying a water content is not limited, and for example, a method such as dew condensation due to the temperature difference between the precursor coating (and base material) and the ambient atmosphere, or spraying of water vapor (steam) may be used.

Water can be supplied under an atmosphere at, for example, 0 to 250° C., preferably 60° C. or more, further preferably 100° C. or more, and preferably 180° C. or less, further preferably 150° C. or less. Water can be supplied in such a temperature range, thereby allowing for progression of hydrolysis. The pressure here is not limited, and can be simply ambient pressure.

Next, the precursor film is heated on the surface of the base material under a dry atmosphere at more than 60° C. The drying and heating method is not limited, and for example, the precursor film together with the base material may be disposed under an atmosphere at a temperature of more than 60° C., preferably more than 100° C., and for example, 250° C. or less, preferably 180° C. or less, and at an unsaturated vapor pressure. The pressure here is not limited, and can be simply ordinary pressure.

Under such an atmosphere, groups bonding to Si after hydrolysis are mutually rapidly dehydrated and condensed between the perfluoro(poly)ether group-containing silane compound of the present invention. A group binding to Si after hydrolysis of the compound and a reactive group present in the surface of the base material are rapidly reacted between the compound and the base material, and are dehydrated and condensed when the reactive group present in the surface of the base material is a hydroxyl group. As a result, the bond between the perfluoro(poly)ether group-containing silane compound and the base material is formed.

For example, the suppling of water, and the drying and heating may be continuously performed by use of superheated water vapor.

The post-treatment can be performed as described above. Such a post-treatment can be performed in order to further increase friction durability, but it is to be noted that such a post-treatment is not essential for production of the article of the present invention. For example, the surface-treating agent of the present invention may also be applied to the surface of the base material and then left to stand as it is.

As described above, the surface-treating layer derived from the film of the surface-treating agent of the present invention is formed on the surface of the base material, and the article of the present invention is produced. The surface-treating layer thus obtained has favorable UV resistance. The surface-treating layer can have not only favorable UV resistance, but also water-repellency, oil-repellency, antifouling property (for example, prevention of attachment of contaminations such as fingerprints), surface lubricity (or lubricity, for example, wiping property of contaminations such as fingerprints, or excellent texture to fingers), high friction durability, and the like, depending on the formulation of a composition used, and can be suitably utilized as a functional thin film.

That is, the present invention also relates to an optical material including the cured product (surface-treating layer) on the outermost layer.

Examples of the optical material preferably include not only optical materials related to a display and the like recited below, but also various optical materials: for example, displays such as a cathode ray tube (CRT; e.g., TV, personal computer monitor), a liquid crystal display, a plasma display, an organic EL display, an inorganic thin-film EL dot matrix display, a rear projection display, a vacuum fluorescent display (VFD), and a field emission display (FED; Field Emission Display), and protective plates of such displays, or such protective plates each provided with a surface onto which an antireflection film is applied.

An article including the surface-treating layer obtained by the present invention is not limited, and can be an optical member. Examples of the optical member include the following: lenses for eyeglasses; a front surface protective plate, an antireflection plate, a polarizing plate, and an anti-glare plate for displays such as PDP and LCD; a touch panel sheet for devices such as a cellular phone and a personal digital assistance; a disc surface for optical discs such as a Blu-ray (registered trademark) disc, a DVD disc, CD-R, and MO; and an optical fiber.

For example, the article including the surface-treating layer obtained by the present invention may be medical equipment or a medical material.

For example, the article including the surface-treating layer obtained by the present invention may be an in-car component.

The thickness of the surface-treating layer is not limited. In the case of an optical member, the thickness of the surface-treating layer is in the range from 1 to 50 nm, more preferably in the range from 1 to 30 nm, particularly preferably in the range from 1 to 15 nm from the viewpoints of optical performance, surface lubricity, friction durability, and antifouling property.

In another embodiment, another layer may be formed on the surface of the base material, and thereafter a film of the surface-treating layer obtained by the present invention may be formed on the surface of such the layer.

The article obtained by use of the surface-treating agent of the present invention is as described above in detail. The application, the usage method, and the production method of the article of the surface-treating agent of the present invention are not limited to those recited above.

### EXAMPLES

The PFPE-containing silane compound of the present invention will be more specifically described with reference to the following Examples, but the present invention is not intended to be limited to these Examples.

### Synthesis Example 1

To a 100-mL four-necked flask equipped with a reflux condenser, a thermometer and a stirrer, 10 g of a perfluoropolyether-modified allyl compound represented by an average compositional formula CF₃CF₂CF₂O(CF₂CF₂CF₂O)₂₀CF₂CF₂CH₂CH═CH₂, 10 g of 1,3-bis(trifluoromethyl)benzene, and 0.7 g of trichlorosilane were added and stirred at 5° C. under a nitrogen stream for 30 minutes. Subsequently, 0.05 ml of a solution containing 2% of a Pt complex of 1,3-divinyl-1,1,3,3-tetramethyldisiloxane in xylene was added thereto, and thereafter the resultant was heated to 60° C., and stirred at that temperature for 3 hours. Thereafter, the volatile content was distilled off under reduced pressure, thereby providing 9 g of perfluoropolyether group-containing silane compound (A) having trichlorosilane at a terminal, represented by the following formula.

Perfluoropolyether Group-Containing Silane Compound (A):

CF₃CF₂CF₂O(CF₂CF₂CF₂O)₂₀CF₂CF₂CH₂CH₂CH₂SiCl₃

### Synthesis Example 2

To a 100-mL four-necked flask equipped with a reflux condenser, a thermometer and a stirrer, 9 g of perfluoropolyether group-containing trichlorosilane compound (A) having trichlorosilane at a terminal, synthesized in Synthesis Example 1, and 15 g of 1,3-bis(trifluoromethyl)benzene were added and stirred at 5° C. under a nitrogen stream for 30 minutes. Subsequently, 14 ml of a solution containing 0.7 mol/L allyl magnesium bromide in diethyl ether was added thereto, and thereafter the resultant was heated to room temperature, and stirred at that temperature for 10 hours. Thereafter, the resultant was cooled to 5° C., 3 ml of methanol was added thereto, thereafter perfluorohexane was added thereto and the mixture was stirred for 30 minutes, and thereafter a perfluorohexane layer was collected by separation with a separating funnel. Subsequently, the volatile content was distilled off under reduced pressure, thereby providing 10 g of the following perfluoropolyether group-containing allyl compound (B) having an allyl group at a terminal.

Perfluoropolyether Group-Containing Allyl Compound (B):

CF₃CF₂CF₂O(CF₂CF₂CF₂O)₂₀CF₂CF₂CH₂CH₂CH₂Si(CH₂CH═CH₂)₃

### Synthesis Example 3

To a 100-mL four-necked flask equipped with a reflux condenser, a thermometer and a stirrer, 10 g of perfluoropolyether group-containing allyl compound (B) having an allyl group at a terminal, synthesized in Synthesis Example 2, 15 g of 1,3-bis(trifluoromethyl)benzene, and 3.15 g of trichlorosilane were added and stirred at 5° C. under a nitrogen stream for 30 minutes. Subsequently, 0.1 ml of a solution containing 2% of a Pt complex of 1,3-divinyl-1,1,3,3-tetramethyldisiloxane in xylene was added thereto, and thereafter the resultant was heated to 60° C., and stirred at that temperature for 2 hours. Thereafter, the volatile content was distilled off under reduced pressure, thereby providing 11 g of the following perfluoropolyether group-containing trichlorosilane compound (C) having trichlorosilane at a terminal.

Perfluoropolyether Group-Containing Trichlorosilane Compound (C):

CF₃CF₂CF₂O(CF₂CF₂CF₂O)₂₀CF₂CF₂CH₂CH₂CH₂Si(CH₂CH₂CH₂SiCl₃)₃

### Synthesis Example 4

To a 100-mL four-necked flask equipped with a reflux condenser, a thermometer and a stirrer, 11 g of perfluoropolyether group-containing trichlorosilane compound (C) having trichlorosilane at a terminal, synthesized in Synthesis Example 3, and 15 g of 1,3-bis(trifluoromethyl)benzene were added and stirred at 50° C. under a nitrogen stream for 30 minutes. Subsequently, a mixed solution of 0.30 g of methanol and 5.4 g of trimethyl orthoformate was added, and thereafter the resultant was heated to 55° C., and stirred at that temperature for 2 hours. Thereafter, the volatile content was distilled off under reduced pressure, thereby providing 11 g of the following perfluoropolyether group-containing silane compound (D) having a trimethoxysilyl group at a terminal.

Perfluoropolyether Group-Containing Silane Compound (D):

CF₃CF₂CF₂O(CF₂CF₂CF₂O)₂₀CF₂CF₂CH₂CH₂CH₂Si[CH₂CH₂CH₂Si(OCH₃)₃]₃

### Synthesis Example 5

To a 100-mL four-necked flask equipped with a reflux condenser, a thermometer and a stirrer, 10 g of a perfluoropolyether-modified allyl compound represented by an average compositional formula CF₃O(CF₂CF₂O)₂₀(CF₂O)₁₆CF₂CH₂CH═CH₂, 14 g of 1,3-bis(trifluoromethyl)benzene, and 1.1 g of trichlorosilane were added and stirred at 5° C. under a nitrogen stream for 30 minutes. Subsequently, 0.08 ml of a solution containing 2% of a Pt complex of 1,3-divinyl-1,1,3,3-tetramethyldisiloxane in xylene was added thereto, and thereafter the resultant was heated to 60° C., stirred at that temperature for 4 hours. Thereafter, the volatile content was distilled off under reduced pressure, thereby providing 10.1 g of perfluoropolyether group-containing trichlorosilane compound (E) having trichlorosilane at a terminal, represented by the following formula.

Perfluoropolyether Group-Containing Trichlorosilane Compound (E):

CF₃O(CF₂CF₂O)₂₀(CF₂O)₁₆CF₂CH₂CH₂CH₂SiCl₃

### Synthesis Example 6

To a 100-mL four-necked flask equipped with a reflux condenser, a thermometer and a stirrer, 10.1 g of perfluoropolyether group-containing trichlorosilane compound (E) having trichlorosilane at a terminal, synthesized in Synthesis Example 5, and 14 g of 1,3-bis(trifluoromethyl)benzene were added and stirred at 5° C. under a nitrogen stream for 30 minutes. Subsequently, 15.7 ml of a solution containing 1 mol/L allyl magnesium chloride in tetrahydrofuran was added thereto, and thereafter the resultant was heated to room temperature, and stirred at that temperature for 12 hours. Thereafter, the resultant was cooled to 5° C., 4.6 ml of methanol was added thereto, thereafter 20 g of perfluorohexane was added and the mixture was stirred for 30 minutes, and thereafter a perfluorohexane layer was collected by separation with a separating funnel. Subsequently, the volatile content was distilled off under reduced pressure, thereby providing 10.3 g of the following perfluoropolyether group-containing allyl compound (F) having an allyl group at a terminal.

Perfluoropolyether Group-Containing Allyl Compound (F):

CF₃O(CF₂CF₂O)₂₀(CF₂O)₁₆CF₂CH₂CH₂CH₂Si(CH₂CH═CH₂)₃

### Synthesis Example 7

To a 100-mL four-necked flask equipped with a reflux condenser, a thermometer and a stirrer, 5.5 g of perfluoropolyether group-containing allyl compound (F) having an allyl group at a terminal, synthesized in Synthesis Example 6, 8 g of 1,3-bis(trifluoromethyl)benzene, and 1.2 g of trichlorosilane were added and stirred at 5° C. under a nitrogen stream for 30 minutes. Subsequently, 0.06 ml of a solution containing 2% of a Pt complex of 1,3-divinyl-1,1,3,3-tetramethyldisiloxane in xylene was added thereto, and thereafter the resultant was heated to 60° C., and stirred at that temperature for 2 hours. Thereafter, the volatile content was distilled off under reduced pressure, thereby providing 5.6 g of the following perfluoropolyether group-containing trichlorosilane compound (G) having trichlorosilane at a terminal.

Perfluoropolyether Group-Containing Trichlorosilane Compound (G):

CF₃O(CF₂CF₂O)₂₀(CF₂O)₁₆CF₂CH₂CH₂CH₂Si(CH₂CH₂CH₂SiCl₃)₃

### Synthesis Example 8

To a 100-mL four-necked flask equipped with a reflux condenser, a thermometer and a stirrer, 5.6 g of perfluoropolyether group-containing trichlorosilane compound (G) having trichlorosilane at a terminal, synthesized in Synthesis Example 7, and 9 g of 1,3-bis(trifluoromethyl)benzene were added and stirred at 50° C. under a nitrogen stream for 30 minutes. Subsequently, a mixed solution of 0.2 g of methanol and 5.8 g of trimethyl orthoformate was added, and thereafter the resultant was heated to 55° C., and stirred at that temperature for 3 hours. Thereafter, the volatile content was distilled off under reduced pressure, thereby providing 5.7 g of the following perfluoropolyether group-containing silane compound (H) having a trimethoxysilyl group at a terminal.

Perfluoropolyether Group-Containing Silane Compound (H):

CF₃O(CF₂CF₂O)₂₀(CF₂O)₁₆CF₂CH₂CH₂CH₂Si[CH₂CH₂CH₂Si(OCH₃)₃]₃

### Synthesis Example 9

To a 100-mL four-necked flask equipped with a reflux condenser, a thermometer and a stirrer, 9 g of perfluoropolyether group-containing silane compound (A) having trichlorosilane at a terminal, synthesized in Synthesis Example 1, and 15 g of 1,3-bis(trifluoromethyl)benzene were added and stirred at 5° C. under a nitrogen stream for 30 minutes. Subsequently, 10 ml of a solution containing 1.6 mol/L vinyl magnesium chloride in tetrahydrofuran was added thereto, and thereafter the resultant was heated to room temperature, and stirred at that temperature for 10 hours. Thereafter, the resultant was cooled to 5° C., 5 ml of methanol was added thereto, thereafter perfluorohexane was added thereto and the mixture was stirred for 30 minutes, and thereafter a perfluorohexane layer was collected by separation with a separating funnel. Subsequently, the volatile content was distilled off under reduced pressure, thereby providing 9.1 g of the following perfluoropolyether group-containing vinyl compound (I) having a vinyl group at a terminal.

Perfluoropolyether Group-Containing Vinyl Compound (I):

CF₃CF₂CF₂O(CF₂CF₂CF₂O)₂₀CF₂CF₂CH₂CH₂CH₂Si(CH═CH₂)₃

### Synthesis Example 10

To a 100-mL four-necked flask equipped with a reflux condenser, a thermometer and a stirrer, 9.1 g of perfluoropolyether group-containing vinyl compound (I) having a vinyl group at a terminal, synthesized in Synthesis Example 9, 12 g of 1,3-bis(trifluoromethyl)benzene, and 3.0 g of trichlorosilane were added and stirred at 5° C. under a nitrogen stream for 30 minutes. Subsequently, 0.1 ml of a solution containing 2% of a Pt complex of 1,3-divinyl-1,1,3,3-tetramethyldisiloxane in xylene was added thereto, and thereafter the resultant was heated to 60° C., and stirred at that temperature for 3 hours. Thereafter, the volatile content was distilled off under reduced pressure, thereby providing 9.2 g of the following perfluoropolyether group-containing trichlorosilane compound (J) having trichlorosilane at a terminal.

Perfluoropolyether Group-Containing Trichlorosilane Compound (J):

CF₃CF₂CF₂O(CF₂CF₂CF₂O)₂₀CF₂CF₂CH₂CH₂CH₂Si(CH₂CH₂SiCl₃)₃

### Synthesis Example 11

To a 100-mL four-necked flask equipped with a reflux condenser, a thermometer and a stirrer, 9.2 g of perfluoropolyether group-containing trichlorosilane compound (J) having trichlorosilane at a terminal, synthesized in Synthesis Example 10, and 12 g of 1,3-bis(trifluoromethyl)benzene were added and stirred at 50° C. under a nitrogen stream for 30 minutes. Subsequently, a mixed solution of 0.40 g of methanol and 13.2 g of trimethyl orthoformate was added, and thereafter the resultant was heated to 55° C., and stirred at that temperature for 3 hours. Thereafter, the volatile content was distilled off under reduced pressure, thereby providing 9.3 g of the following perfluoropolyether group-containing silane compound (K) having a trimethoxysilyl group at a terminal.

Perfluoropolyether Group-Containing Silane Compound (K):

CF₃CF₂CF₂O(CF₂CF₂CF₂O)₂₀CF₂CF₂CH₂CH₂CH₂Si[CH₂CH₂Si(OCH₃)₃]₃

### Synthesis Example 12

To a 100-mL four-necked flask equipped with a reflux condenser, a thermometer and a stirrer, 10.1 g of perfluoropolyether group-containing trichlorosilane compound (E) having trichlorosilane at a terminal, synthesized in Synthesis Example 5, and 12 g of 1,3-bis(trifluoromethyl)benzene were added and stirred at 5° C. under a nitrogen stream for 30 minutes. Subsequently, 9.5 ml of a solution containing 1.6 mol/L vinyl magnesium chloride in tetrahydrofuran was added thereto, and thereafter the resultant was heated to room temperature, and stirred at that temperature for 12 hours. Thereafter, the resultant was cooled to 5° C., 6 ml of methanol was added thereto, thereafter 20 g of perfluorohexane was added thereto and the mixture was stirred for 30 minutes, and thereafter a perfluorohexane layer was collected by separation with a separating funnel. Subsequently, the volatile content was distilled off under reduced pressure, thereby providing 10.2 g of the following perfluoropolyether group-containing vinyl compound (L) having a vinyl group at a terminal.

Perfluoropolyether Group-Containing Vinyl Compound (L):

CF₃O(CF₂CF₂O)₂₀(CF₂O)₁₆CF₂CH₂CH₂CH₂Si(CH═CH₂)₃

### Synthesis Example 13

To a 100-mL four-necked flask equipped with a reflux condenser, a thermometer and a stirrer, 6.0 g of perfluoropolyether group-containing vinyl compound (L) having a vinyl group at a terminal, synthesized in Synthesis Example 12, 9 g of 1,3-bis(trifluoromethyl)benzene, and 1.5 g of trichlorosilane were added and stirred at 5° C. under a nitrogen stream for 30 minutes. Subsequently, 0.06 ml of a solution containing 2% of a Pt complex of 1,3-divinyl-1,1,3,3-tetramethyldisiloxane in xylene was added thereto, and thereafter the resultant was heated to 60° C., and stirred at that temperature for 2 hours. Thereafter, the volatile content was distilled off under reduced pressure, thereby providing 6.1 g of the following perfluoropolyether group-containing trichlorosilane compound (M) having trichlorosilane at a terminal.

Perfluoropolyether Group-Containing Trichlorosilane Compound (M):

CF₃O(CF₂CF₂O)₂₀(CF₂)₁₆CF₂CH₂CH₂CH₂Si(CH₂CH₂SiCl₃)₃

### Synthesis Example 14

To a 100-mL four-necked flask equipped with a reflux condenser, a thermometer and a stirrer, 6.1 g of perfluoropolyether group-containing trichlorosilane compound (M) having trichlorosilane at a terminal, synthesized in Synthesis Example 13, and 9 g of 1,3-bis(trifluoromethyl)benzene were added and stirred at 50° C. under a nitrogen stream for 30 minutes.

Subsequently, a mixed solution of 0.25 g of methanol and 8.3 g of trimethyl orthoformate was added, and thereafter the resultant was heated to 55° C., and stirred at that temperature for 3 hours. Thereafter, the volatile content was distilled off under reduced pressure, thereby providing 6.2 g of the following perfluoropolyether group-containing silane compound (N) having a trimethoxysilyl group at a terminal.

Perfluoropolyether group-containing silane compound (N):

CF₃(CF₂CF₂O)₂₀(CF₂O)₁₆CF₂CH₂CH₂CH₂Si[CH₂CH₂Si(OCH₃)₃]₃

### Synthesis Example 15

To a 100-mL four-necked flask equipped with a reflux condenser, a thermometer and a stirrer, 10.0 g of perfluoropolyether group-containing trichlorosilane compound (E) having trichlorosilane at a terminal, synthesized in Synthesis Example 5, and 12 g of 1,3-bis(trifluoromethyl)benzene were added and stirred at 5° C. under a nitrogen stream for 30 minutes. Subsequently, 16.5 ml of a solution containing 1.0 mol/L butenyl magnesium bromide in tetrahydrofuran was added thereto, and thereafter the resultant was heated to room temperature, and stirred at that temperature for 12 hours. Thereafter, the resultant was cooled to 5° C., 6 ml of methanol was added thereto, thereafter 20 g of perfluorohexane was added thereto and the mixture was stirred for 30 minutes, and thereafter a perfluorohexane layer was collected by separation with a separating funnel. Subsequently, the volatile content was distilled off under reduced pressure, thereby providing 10.1 g of the following perfluoropolyether group-containing butenyl compound (O) having a butenyl group at a terminal.

Perfluoropolyether Group-Containing Butenyl Compound (O):

CF₃O(CF₂CF₂O)₂₀(CF₂O)₁₆CF₂CH₂CH₂CH₂Si(CH₂CH₂CH═CH₂)₃

### Synthesis Example 16

To a 100-mL four-necked flask equipped with a reflux condenser, a thermometer and a stirrer, 6.0 g of perfluoropolyether group-containing butenyl compound (O) having a butenyl group at a terminal, synthesized in Synthesis Example 15, 9 g of 1,3-bis(trifluoromethyl)benzene, and 1.5 g of trichlorosilane were added and stirred at 5° C. under a nitrogen stream for 30 minutes. Subsequently, 0.06 ml of a solution containing 2% of a Pt complex of 1,3-divinyl-1,1,3,3-tetramethyldisiloxane in xylene was added thereto, and thereafter the resultant was heated to 60° C., and stirred at that temperature for 2 hours. Thereafter, the volatile content was distilled off under reduced pressure, thereby providing 6.1 g of the following perfluoropolyether group-containing trichlorosilane compound (P) having trichlorosilane at a terminal.

Perfluoropolyether Group-Containing Trichlorosilane Compound (P):

CF₃O(CF₂CF₂O)₂₀(CF₂O)₁₆CF₂CH₂CH₂CH₂Si(CH₂CH₂CH₂CH₂SiCl₃)₃

### Synthesis Example 17

To a 100-mL four-necked flask equipped with a reflux condenser, a thermometer and a stirrer, 6.1 g of perfluoropolyether group-containing trichlorosilane compound (P) having trichlorosilane at a terminal, synthesized in Synthesis Example 16, and 9 g of 1,3-bis(trifluoromethyl)benzene were added and stirred at 50° C. under a nitrogen stream for 30 minutes. Subsequently, a mixed solution of 0.25 g of methanol and 8.3 g of trimethyl orthoformate was added, and thereafter the resultant was heated to 55° C., and stirred at that temperature for 3 hours. Thereafter, the volatile content was distilled off under reduced pressure, thereby providing 6.2 g of the following perfluoropolyether group-containing silane compound (Q) having a trimethoxysilyl group at a terminal.

Perfluoropolyether Group-Containing Silane Compound (Q):

CF₃O(CF₂CF₂O)₂₀(CF₂O)₁₆CF₂CH₂CH₂CH₂Si[CH₂CH₂CH₂CH₂Si(OCH₃)₃]₃

### Synthesis Example 18

To a 100-mL four-necked flask equipped with a reflux condenser, a thermometer and a stirrer, 10.0 g of perfluoropolyether group-containing trichlorosilane compound (E) having trichlorosilane at a terminal, synthesized in Synthesis Example 5, and 12 g of 1,3-bis(trifluoromethyl)benzene were added and stirred at 5° C. under a nitrogen stream for 30 minutes. Subsequently, 16.5 ml of a solution containing 1.0 mol/L hexenyl magnesium bromide in tetrahydrofuran was added thereto, and thereafter the resultant was heated to room temperature, and stirred at that temperature for 12 hours. Thereafter, the resultant was cooled to 5° C., 6 ml of methanol was added thereto, thereafter 20 g of perfluorohexane was added thereto and the mixture was stirred for 30 minutes, and thereafter a perfluorohexane layer was collected by separation with a separating funnel. Subsequently, the volatile content was distilled off under reduced pressure, thereby providing 10.1 g of the following perfluoropolyether group-containing hexenyl compound (R) having a hexenyl group at a terminal.

Perfluoropolyether Group-Containing Hexenyl Compound (R):

CF₃O(CF₂CF₂O)₂₀(CF₂O)₁₆CF₂CH₂CH₂CH₂Si(CH₂CH₂CH₂CH₂CH═CH₂)₃

### Synthesis Example 19

To a 100-mL four-necked flask equipped with a reflux condenser, a thermometer and a stirrer, 6.0 g of perfluoropolyether group-containing hexenyl compound (R) having a hexenyl group at a terminal, synthesized in Synthesis Example 18, 9 g of 1,3-bis(trifluoromethyl)benzene, and 1.5 g of trichlorosilane were added and stirred at 5° C. under a nitrogen stream for 30 minutes. Subsequently, 0.06 ml of a solution containing 2% of a Pt complex of 1,3-divinyl-1,1,3,3-tetramethyldisiloxane in xylene was added thereto, and thereafter the resultant was heated to 60° C., and stirred at that temperature for 2 hours. Thereafter, the volatile content was distilled off under reduced pressure, thereby providing 6.1 g of the following perfluoropolyether group-containing trichlorosilane compound (S) having trichlorosilane at a terminal.

Perfluoropolyether Group-Containing Trichlorosilane Compound (S):

CF₃O(CF₂CF₂O)₂₀(CF₂)₁₆CF₂CH₂CH₂CH₂Si(CH₂CH₂CH₂CH₂CH₂CH₂SiCl₃)₃

### Synthesis Example 20

To a 100-mL four-necked flask equipped with a reflux condenser, a thermometer and a stirrer, 6.1 g of perfluoropolyether group-containing trichlorosilane compound (S) having trichlorosilane at a terminal, synthesized in Synthesis Example 19, and 9 g of 1,3-bis(trifluoromethyl)benzene were added and stirred at 50° C. under a nitrogen stream for 30 minutes. Subsequently, a mixed solution of 0.25 g of methanol and 8.3 g of trimethyl orthoformate was added, and thereafter the resultant was heated to 55° C., and stirred at that temperature for 3 hours. Thereafter, the volatile content was distilled off under reduced pressure, thereby providing 6.2 g of the following perfluoropolyether group-containing silane compound (T) having a trimethoxysilyl group at a terminal.

Perfluoropolyether Group-Containing Silane Compound (T):

CF₃O(CF₂CF₂O)₂₀(CF₂O)₁₆CF₂CH₂CH₂CH₂Si[CH₂CH₂CH₂CH₂CH₂CH₂Si(OCH₃)₃]₃

### Synthesis Example 21

To a 100-mL four-necked flask equipped with a reflux condenser, a thermometer and a stirrer, 13 g of a perfluoropolyether-modified allyl compound represented by an average compositional formula CF₃O(CF₂CF₂O)₂₁(CF₂O)₂₉CF₂CH₂CH═CH₂, 15.6 g of 1,3-bis(trifluoromethyl)benzene, and 1.3 g of trichlorosilane were added and stirred at 5° C. under a nitrogen stream for 30 minutes. Subsequently, 0.10 ml of a solution containing 2% of a Pt complex of 1,3-divinyl-1,1,3,3-tetramethyldisiloxane in xylene was added thereto, and thereafter the resultant was heated to 60° C., and stirred at that temperature for 4 hours. Thereafter, the volatile content was distilled off under reduced pressure, thereby providing 13.2 g of perfluoropolyether group-containing trichlorosilane compound (U) having trichlorosilane at a terminal, represented by the following formula.

Perfluoropolyether Group-Containing Trichlorosilane Compound (U):

CF₃O(CF₂CF₂O)₂₁(CF₂O)₂₉CF₂CH₂CH₂CH₂SiCl₃

### Synthesis Example 22

To a 100-mL four-necked flask equipped with a reflux condenser, a thermometer and a stirrer, 13.2 g of perfluoropolyether group-containing trichlorosilane compound (U) having trichlorosilane at a terminal, synthesized in Synthesis Example 21, and 15.6 g of 1,3-bis(trifluoromethyl)benzene were added and stirred at 5° C. under a nitrogen stream for 30 minutes. Subsequently, 17.8 ml of a solution containing 1 mol/L allyl magnesium chloride in tetrahydrofuran was added thereto, and thereafter the resultant was heated to room temperature, and stirred at that temperature for 12 hours. Thereafter, the resultant was cooled to 5° C., 7.1 ml of methanol was added thereto, thereafter 30 g of perfluorohexane was added thereto and the mixture was stirred for 30 minutes, and thereafter a perfluorohexane layer was collected by separation with a separating funnel. Subsequently, the volatile content was distilled off under reduced pressure, thereby providing 13.0 g of the following perfluoropolyether group-containing allyl compound (V) having an allyl group at a terminal.

Perfluoropolyether Group-Containing Allyl Compound (V):

CF₃O(CF₂CF₂O)₂₁(CF₂O)₂₉CF₂CH₂CH₂CH₂Si(CH₂CH═CH₂)₃

### Synthesis Example 23

To a 100-mL four-necked flask equipped with a reflux condenser, a thermometer and a stirrer, 12.5 g of perfluoropolyether group-containing allyl compound (V) having an allyl group at a terminal, synthesized in Synthesis Example 22, 17.3 g of 1,3-bis(trifluoromethyl)benzene, and 2.5 g of trichlorosilane were added and stirred at 5° C. under a nitrogen stream for 30 minutes. Subsequently, 0.17 ml of a solution containing 2% of a Pt complex of 1,3-divinyl-1,1,3,3-tetramethyldisiloxane in xylene was added thereto, and thereafter the resultant was heated to 60° C., and stirred at that temperature for 2 hours. Thereafter, the volatile content was distilled off under reduced pressure, thereby providing 12.6 g of the following perfluoropolyether group-containing trichlorosilane compound (W) having trichlorosilane at a terminal.

Perfluoropolyether Group-Containing Trichlorosilane Compound (W):

CF₃O(CF₂CF₂O)₂₁(CF₂O)₂₉CF₂CH₂CH₂CH₂Si(CH₂CH₂CH₂SiCl₃)₃

### Synthesis Example 24

To a 100-mL four-necked flask equipped with a reflux condenser, a thermometer and a stirrer, 12.6 g of perfluoropolyether group-containing trichlorosilane compound (W) having trichlorosilane at a terminal, synthesized in Synthesis Example 23, and 17 g of 1,3-bis(trifluoromethyl)benzene were added and stirred at 50° C. under a nitrogen stream for 30 minutes. Subsequently, a mixed solution of 0.4 g of methanol and 13.3 g of trimethyl orthoformate was added, and thereafter the resultant was heated to 55° C., and stirred at that temperature for 3 hours. Thereafter, the volatile content was distilled off under reduced pressure, thereby providing 12.7 g of the following perfluoropolyether group-containing silane compound (X) having a trimethoxysilyl group at a terminal.

Perfluoropolyether Group-Containing Silane Compound (X):

CF₃O(CF₂CF₂O)₂₁(CF₂O)₂₉CF₂CH₂CH₂CH₂Si[CH₂CH₂CH₂Si(OCH₃)₃]₃

### Example 1

Compound (D) obtained in Synthesis Example 4 was dissolved in hydrofluoroether (NOVEC HFE 7200 manufactured by 3M) so that the concentration was 20% by weight, thereby preparing surface-treating agent 1.

Surface-treating agent 1 prepared above was vapor-deposited on chemically reinforced glass (“Gorilla” glass having a thickness of 0.7 mm, manufactured by Corning Incorporated). Such a vacuum deposition treatment was at a pressure of 3.0×10⁻³ Pa. First, silicon dioxide at a thickness of 7 nm was deposited on the surface of the chemically reinforced glass to form a silicon dioxide film, and subsequently 2 mg of a surface-treating agent (namely, containing 0.4 mg of compound (D)) per the chemically reinforced glass (55 mm×100 mm) was deposited. Thereafter, the chemically reinforced glass with a deposited film was left to still stand under an atmosphere of a temperature of 20° C. and a humidity of 65% for 24 hours. Thus, the deposited film was cured, thereby forming a surface-treating layer.

### Example 2

A surface-treating agent was prepared and a surface-treating layer was formed in the same manner as in Example 1 except that compound (H) was used instead of compound (D).

### Examples 3 to 4

Each surface-treating agent was prepared and each surface-treating layer was formed in the same manner as in Example 1 except that compound (K) or compound (N) was used instead of compound (D).

### Examples 5 to 6

Each surface-treating agent was prepared and each surface-treating layer was formed in the same manner as in Example 1 except that compound (Q) or compound (T) was used instead of compound (D).

### Example 7

A surface-treating agent was prepared and a surface-treating layer was formed in the same manner as in Example 1 except that compound (X) was used instead of compound (D).

### Comparative Example 1

A surface-treating agent was prepared and a surface-treating layer was formed in the same manner as in Example 1 except that the following control compound 1 was used instead of compound (D).

Control Compound 1

CF₃CF₂CF₂O(CF₂CF₂CF₂O)₂₀CF₂CF₂CH₂OCH₂CH₂CH₂Si[CH₂CH₂CH₂Si(OCH₃)₃]₃

### Comparative Example 2

A surface-treating agent was prepared and a surface-treating layer was formed in the same manner as in Example 1 except that the following control compound 2 was used instead of compound (D).

Control Compound 2

CF₃O(CF₂CF₂O)₂₀(CF₂O)₁₆CF₂CH₂OCH₂CH₂CH₂Si[CH₂CH₂CH₂Si(OCH₃)₃]₃

### (Evaluation of UV Resistance)

The static contact angle of water with each of the surface-treating layers formed in Examples and Comparative Examples was measured before and after UV irradiation. UV irradiation was conducted by using a UVB-313 lamp (manufactured by Q-Lab Corporation, irradiance at 310 nm: 0.63 W/m²) at a distance of 5 cm between the lamp and the surface-treating layer. The static contact angle of water was measured with respect to 1 μL of water by using a contact angle measurement apparatus (manufactured by Kyowa Interface Science, Inc.)

First, the static contact angle of water with each of the formed surface-treating layers before UV irradiation (UV irradiation time: 0 hours) was measured as the initial evaluation. Thereafter, the static contact angle of water with each of the formed surface-treating layers after UV irradiation for a predetermined time was measured. The evaluation of UV resistance was performed for a cumulative irradiation time of 96 hours. The results are shown in Table 1.

TABLE 1

| Cumulative | | | | | | | | | |
|---|---|---|---|---|---|---|---|---|---|
| UV | Contact angle (degrees) | | | | | | | | |
| irradiation | | | | | | | | Comparative | Comparative |
| time (hours) | Example 1 | Example 2 | Example 3 | Example 4 | Example 5 | Example 6 | Example 7 | Example 1 | Example 2 |
| 0 | 116 | 116 | 116 | 116 | 116 | 115 | 116 | 116 | 116 |
| 24 | 116 | 115 | 116 | 116 | 115 | 115 | 115 | 115 | 116 |
| 48 | 115 | 115 | 115 | 115 | 115 | 115 | 115 | 104 | 108 |
| 72 | 115 | 115 | 115 | 115 | 114 | 114 | 115 | 94 | 97 |
| 96 | 115 | 115 | 115 | 115 | 114 | 114 | 114 | 86 | 84 |

### (Evaluation of Friction Durability)

Each of the surface-treating layers formed in Examples 1 to 7 and Comparative Examples 1 to 2 was subjected to the following friction durability test as the evaluation of durability in practical use.

The static contact angle of water of the surface of the surface-treating layer of which the surface had not still contacted with anything after formation thereof (number of times of friction: zero), was measured as the initial evaluation.

Thereafter, a sample article on which each of the surface-treating layers was formed was horizontally disposed, the following friction block was brought into contact with the surface of each of the surface-treating layers (the contact surface had a circular shape having a diameter of 1 cm), a load of 5 N was applied thereonto, and thereafter the friction block was allowed to reciprocate at a rate of 40 mm/sec with the load being applied. The friction block was allowed to reciprocate at most 4000 times, and the static contact angle of water (degrees) was measured every a number of times of reciprocation (number of times of friction) of 1000. The test was stopped when the measurement value of the static contact angle of water was decreased to less than 60 degrees. The static contact angle of water was measured in the same manner as in the evaluation of UV resistance. The results are shown in Table 2 (the sign “-” in the Table means no measurement).

Friction Block

A silicone rubber product shown below, the surface (diameter: 1 cm) of which was covered with a cotton impregnated with artificial sweat having the following composition, was used as a friction block.

Composition of Artificial Sweat

Anhydrous disodium hydrogen phosphate: 2 g

Sodium chloride: 20 g

85% Lactic acid: 2 g

Histidine hydrochloride: 5 g

Distilled water: 1 kg

Silicone Rubber Product

Silicone rubber plug SR-51 manufactured by Tigers Polymer Corporation, processed into a cylinder shape having a diameter of 1 cm and a thickness of 1 cm.

TABLE 2

| Number of | | | | | | | | | |
|---|---|---|---|---|---|---|---|---|---|
| times of | Contact angle (degrees) | | | | | | | | |
| friction | | | | | | | | Comparative | Comparative |
| (times) | Example 1 | Example 2 | Example 3 | Example 4 | Example 5 | Example 6 | Example 7 | Example 1 | Example 2 |
| 0 | 116 | 116 | 116 | 116 | 115 | 115 | 116 | 116 | 116 |
| 1000 | 109 | 112 | 111 | 113 | 110 | 109 | 113 | 89 | 105 |
| 2000 | 104 | 108 | 107 | 111 | 106 | 102 | 110 | 80 | 89 |
| 3000 | 96 | 102 | 101 | 107 | 101 | 96 | 105 | 58 | 62 |
| 4000 | 92 | 99 | 95 | 103 | 94 | 86 | 101 | — | 54 |

It was found from the results in Table 1 that the surface-treating layers of Examples 1 to 7 were suppressed in a decrease in the contact angle due to UV irradiation as compared with the surface-treating layers of Comparative Examples 1 and 2. The reason for this was considered because the surface-treating layers formed in Examples 1 to 7 were suppressed in decomposition of the surface-treating layers due to UV irradiation. In other words, it has been confirmed that the surface-treating layer formed by use of the perfluoropolyether group-containing silane compound of the present invention, having a linker made of only an alkylene group, is enhanced in UV resistance.

It was found from the results in Table 2 that the surface-treating layers of Examples 1 to 7 were suppressed in a decrease in the contact angle and had excellent friction durability. The reason for this was considered because the surface-treating layers of Examples 1 to 7 were suppressed in degradation due to chemicals and furthermore the surface-treating layers were enhanced in friction resistance due to PFPE chains closely oriented owing to a surface-treating agent having an alkylene group as a linker (namely, X). In other words, it has been confirmed that the surface-treating layer formed by use of the perfluoropolyether group-containing silane compound of the present invention, having a linker made of only an alkylene group, is enhanced in chemical resistance and abrasion resistance.

The e/f ratio of compound (H) contained in the surface-treating agent in Example 2 was 1.25, and the e/f ratio of compound (X) contained in the surface-treating agent of Example 7 was 0.72. It was considered that compound (X) contained in the surface-treating agent in Example 7 was lower in the content of a (CF₂CF₂O) unit than the content of a (CF₂O) unit and therefore the surface-treating layer formed was easily slid to result in a further enhancement in friction durability.

### INDUSTRIAL APPLICABILITY

The present invention can be suitably utilized for forming a surface-treating layer on surfaces of various base materials, in particular, on a surface of an optical member required to have permeability.

1-17. (canceled)

18. A perfluoro(poly)ether group-containing silane compound represented by formula (A1) or formula (A2):
Rf-PFPE-X—SiR^{a}ₖR^{b}ₗR^{c}ₘ (A1)
R^{c}ₘR^{b}ₗR^{a}ₖSi—X-PFPE-X—SiR^{a}ₖR^{b}ₗR^{c}ₘ (A2)
wherein:
PFPE represents, each independently at each occurrence, a group represented by formula: —(OC₆F₁₂)ₐ—(OC₅F₁₀)_{b}—(OC₄F₈)_{c}—(OC₃F₆)_{d}—(OC₂F₄)ₑ—(OCF₂)_{f}—
wherein a, b, c, d, e and f are each independently an integer of 0 or more and 200 or less, the sum of a, b, c, d, e and f is at least 1, and the occurrence order of respective repeating units in parentheses with a symbol a, b, c, d, e or f is not limited in the formula;
Rf represents, each independently at each occurrence, an alkyl group having 1 to 16 carbon atoms, optionally substituted with one or more fluorine atoms;
X represents, each independently at each occurrence, a substituted or unsubstituted alkylene group having 2 to 20 carbon atoms;
R^{a} represents, each independently at each occurrence, —Z—SiR¹ₚR²_{q}R³ᵣ;
Z represents, each independently at each occurrence, an oxygen atom or a divalent organic group;
R¹ represents, each independently at each occurrence, R^{a′};
R^{a′} has the same definition as R^{a};
the number of Si atoms linearly linked via Z group in R^{a} is up to 5;
R² represents, each independently at each occurrence, a hydroxyl group or a hydrolyzable group;
R³ represents, each independently at each occurrence, a hydrogen atom or a lower alkyl group;
p is, each independently at each occurrence, an integer of 0 to 3;
q is, each independently at each occurrence, an integer of 0 to 3;
r is, each independently at each occurrence, an integer of 0 to 3;
provided that the sum of p, q and r in each —Z—SiR¹ₚR²_{q}R³ᵣ is 3, and two or more Si atoms having at least one R² are present in the formulae (A1) and (A2);
R^{b} represents, each independently at each occurrence, a hydroxyl group or a hydrolyzable group;
R^{c} represents, each independently at each occurrence, a hydrogen atom or a lower alkyl group;
k is, each independently at each occurrence, an integer of 1 to 3;
l is, each independently at each occurrence, an integer of 0 to 2; and
m is, each independently at each occurrence, an integer of 0 to 2;
provided that the sum of k, l and m in each —SiR^{a}ₖR^{b}ₗR^{c}ₘ is 3.

19. The perfluoro(poly)ether group-containing silane compound according to claim 18, wherein X represents an unsubstituted alkylene group having 2 to 10 carbon atoms.

20. The perfluoro(poly)ether group-containing silane compound according to claim 18, wherein k is, each independently at each occurrence, 2 or 3.

21. The perfluoro(poly)ether group-containing silane compound according to claim 18, wherein Z is an alkylene group.

22. The perfluoro(poly)ether group-containing silane compound according to claim 18, wherein the number of Si atoms linearly linked via Z group in R^{a} is 1 or 2.

23. The perfluoro(poly)ether group-containing silane compound according to claim 18, wherein the number of Si atoms linearly linked via Z group in R^{a} is 1.

24. The perfluoro(poly)ether group-containing silane compound according to claim 18, wherein Rf is a perfluoroalkyl group having 1 to 16 carbon atoms.

25. The perfluoro(poly)ether group-containing silane compound according to claim 18, wherein
PFPE is represented by the following formula (a), (b) or (c):
—(OC₃F₆)_{d}— (a)
wherein d is an integer of 1 or more and 200 or less;
—(OC₄F₈)_{c}—(OC₃F₆)_{d}—(OC₂F₄)ₑ—(OCF₂)_{f}— (b)
wherein c and d are each independently an integer of 0 or more and 30 or less;
e and f are each independently an integer of 1 or more and 200 or less;
the sum of c, d, e and f is an integer of 10 or more and 200 or less; and
the occurrence order of respective repeating units in parentheses with a subscript c, d, e or f is not limited in the formula;
—(R⁶—R⁷)ⱼ— (c)
wherein R⁶ is OCF₂ or OC₂F₄;
R⁷ is a group selected from OC₂F₄, OC₃F₆, OC₄F₈, OC₅F₁₀ and OC₆F₁₂, or a combination of two or three groups selected therefrom; and
j is an integer of 2 to 100.

26. The perfluoro(poly)ether group-containing silane compound according to claim 18, wherein
Rf is perfluoroalkyl group having 1 to 16 carbon atoms,
PFPE is represented by the following formula (a), (b) or (c):
—(OC₃F₆)_{d}— (a)
wherein d is an integer of 1 or more and 200 or less;
—(OC₄F₈)_{c}—(OC₃F₆)_{d}—(OC₂F₄)ₑ—(OCF₂)_{f}— (b)
wherein c and d are each independently an integer of 0 or more and 30 or less;
e and f are each independently an integer of 1 or more and 200 or less;
the sum of c, d, e and f is an integer of 10 or more and 200 or less; and
the occurrence order of respective repeating units in parentheses with a subscript c, d, e or f is not limited in the formula;
—(R⁶—R⁷)ⱼ— (c)
wherein R⁶ is OCF₂ or OC₂F₄;
R⁷ is a group selected from OC₂F₄, OC₃F₆, OC₄F₈, OC₅F₁₀ and OC₆F₁₂, or a combination of two or three groups selected therefrom;
j is an integer of 2 to 100;
X is an unsubstituted linear alkylene group having 2 to 10 carbon atoms;
k is 3; and
q is 3.

27. A surface-treating agent comprising at least one perfluoro(poly)ether group-containing silane compound represented by formula (A1) and/or formula (A2) according to claim 18.

28. The surface-treating agent according to claim 27, further comprising one or more other components selected from a fluorine-containing oil, a silicone oil, an alcohol, a catalyst, a transition metal, a halide ion, and a compound containing an atom having an unshared electron pair in a molecular structure.

29. The surface-treating agent according to claim 28, further comprising a solvent.

30. The surface-treating agent according to claim 27, which is used as an antifouling coating agent or a water-proof coating agent.

31. A pellet comprising the surface-treating agent according to claim 27.

32. An article comprising a base material, and a layer formed from the compound according to claim 18 on the surface of the base material.

33. The article according to claim 32, wherein the article is an optical member.

34. The article according to claim 32, wherein the article is a display.

35. An article comprising a base material, and a layer formed from the surface-treating agent according to claim 27 on the surface of the base material.

36. The article according to claim 35, wherein the article is an optical member.

37. The article according to claim 35, wherein the article is a display.
